(19) United States
(12) Patent Application Publication
(10) Pub. No.: US 2015/0229705 A1
(43) Pub. Date: Aug. 13, 2015

(54) COMMUNICATIONS APPARATUS, COMMUNICATIONS METHOD, COMPUTER PRODUCT, AND COMMUNICATIONS SYSTEM

(71) Applicant: Fujitsu Limited, Kawasaki-shi (JP)

(72) Inventors: Takahisa SUZUKI, Yokohama (JP); Koichiro Yamashita, Hachioji (JP); Hiromasa Yamauchi, Usakos (NA); Toshiya Otomo, Kawasaki (JP)

(73) Assignee: Fujitsu Limited, Kawasaki-shi (JP)

(21) Appl. No.: 14/670,006

(22) Filed: Mar. 26, 2015

Related U.S. Application Data
(63) Continuation of application No. PCT/JP2012/074990, filed on Sep. 27, 2012.

(51) Int. Cl. H04L 29/08; H04W 8/24

(52) U.S. Cl. CPC H04L 67/10; H04L 67/12; H04W 8/24

(57) ABSTRACT

A communications apparatus includes a receiving circuit that, when sending a startup instruction to start up another communications apparatus within a communication area, receives from the other communications apparatus, information indicating a period required for startup of the other communications apparatus; a processor that stores to a storage device, a standby period based on the period indicated by the information received by the receiving circuit; a communications circuit that sends the startup instruction within the communication area; and a timer that detects that the standby period stored in the storage device by the processor has elapsed after sending of the startup instruction from the communications circuit. The communications circuit sends data within the communication area when the timer detects that the standby period has elapsed.

### CROSS REFERENCE TO RELATED APPLICATIONS

This application is a continuation application of International Application PCT/JP2012/074990, filed on Sep. 27, 2012 and designating the U.S., the entire contents of which are incorporated herein by reference.

### FIELD

The embodiments discussed herein are related to a communications apparatus, a communications method, a computer product, and a communications system.

### BACKGROUND

A sensor network (wireless sensor network (WSN)) is known which includes plural sensor-equipped wireless terminals (hereinafter, referred to as “sensor nodes”) that are disposed in an installation area and cooperate to gather information indicating the external environment or a physical state.

For imaging apparatuses, there is a technique that sends a command signal to turn on a power source to an image recording apparatus by radio and, after receiving a standby signal from the image recording apparatus, sends data to the image recording apparatus (see, e.g., Japanese Laid-Open Patent Publication No. 2000-253292). For servers, there is a technique that sends a power-on packet to clients and, when receiving data reception ready notification from all the clients, sends data to all the clients (see, e.g., Japanese Laid-Open Patent Publication No. 2003-044288).

In the conventional techniques above, however, since the apparatus on the data sending-side sends the data after receiving a response from the apparatus on the data receiving-side, the wait time until the data is sent tends to be long.

### SUMMARY

According to an aspect of an embodiment, a communications apparatus includes a receiving circuit that, when sending a startup instruction to start up another communications apparatus within a communication area, receives from the other communications apparatus, information indicating a period required for startup of the other communications apparatus; a processor that stores to a storage device, a standby period based on the period indicated by the information received by the receiving circuit; a communications circuit that sends the startup instruction within the communication area; and a timer that detects that the standby period stored in the storage device by the processor has elapsed after sending of the startup instruction from the communications circuit. The communications circuit sends data within the communication area when the timer detects that the standby period has elapsed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of an example of communication between sensor nodes in a sensor network;

FIG. 2 is a block diagram of an internal configuration example of a sensor node 101;

FIG. 3 is an explanatory view of an example of data indicating a detection result of a sensor 206;

FIG. 4 is an explanatory view of an example of a response for data 300;

FIG. 5 is a block diagram of a functional configuration example of the sensor node 101 functioning as a sending-side communications apparatus;

FIG. 6 is a block diagram of a functional configuration example of the sensor node 101 functioning as a receiving-side communications apparatus;

FIGS. 7, 8, 9, 10, 11, 12, 13, 14, 15, and 16 are explanatory views of an example of first communication between the sensor nodes 101;

FIGS. 17, 18, 19, and 20 are explanatory views of examples of second and subsequent communications between the sensor nodes 101;

FIGS. 21 and 22 are explanatory views of a setting example 1 of a standby period in a case of receiving a response 400 from plural sensor nodes 101;

FIG. 23 is a flowchart of an example of a data sending process performed by the sensor node 101 in a case of employing the setting example 1;

FIG. 24 is a flowchart of an example of a standby period setting process performed by the sensor node 101 in the case of employing the setting example 1;

FIGS. 25 and 26 are flowcharts of an example of a data receiving process performed by the sensor node 101 in the case of employing the setting example 1;

FIG. 27 is an explanatory view of density of sensor nodes 101;

FIG. 28 is an explanatory view of an example of the storage contents of a startup period table;

FIG. 29 is an explanatory view of a setting example 2 of the standby period using a startup period table 2800; and

FIG. 30 is a flowchart of an example of the data receiving process performed by the sensor node 101 in the case of employing the setting example 2.

### DESCRIPTION OF EMBODIMENTS

Embodiments of a communications apparatus, a communications method, a communication program, and a communications system will now be described in detail with reference to the accompanying drawings. Hereinafter, a sensor node that has functions of the communications apparatus according to the present invention and that implements the communications system according to the present invention will be described as an example, the invention is not limited hereto. For example, the communications apparatus according to the present invention is applicable to communications apparatuses other than a sensor node.

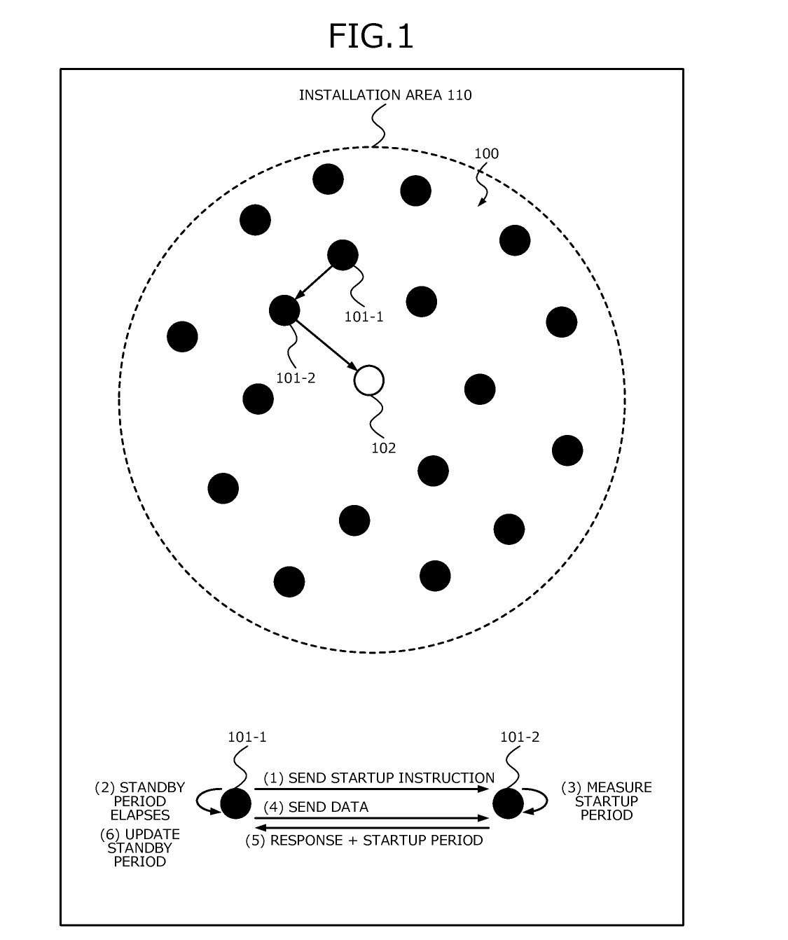

FIG. 1 is a diagram of an example of communication between sensor nodes in a sensor network. FIG. 1 depicts a configuration example of a sensor network 100 and an example of a flow of communication by a sensor node 101 in the sensor network 100.

As depicted in FIG. 1, the sensor network 100 is a communications system that includes chip-like sensor nodes 101 arranged in a given installation area 110 and a parent node 102 that receives sensor output of the sensor nodes 101 by radio, etc. The installation area 110 is, for example, an area filled with a substance such as concrete, soil, water, and air. The installation area 110 may be an area in a vacuum state such as cosmic space.

The sensor node 101 is a computer that detects a given displacement at the installation site within the installation area 110 and sends data related to detection to the parent node 102 via wireless communication. The parent node 102 is a computer that aggregates data obtained from the sensor nodes 101 disposed in the installation area 110 and uploads the data to a server as an external device. The parent node 102 may, for example, notify a user terminal as an external device of data related to detection by the sensor node 101 at an installation site. The parent node 102 may act as the sensor node 101.

Plural sensor nodes 101 (black circles in FIG. 1) are disposed within the installation area 110 as depicted in FIG. 1. A single parent node 102 (a white circle in FIG. 1) is disposed at a site in the installation area 110. The sensor node 101 has merely to have short-distance wireless communication ability or output radio waves reaching at least the adjacent sensor nodes 101. Hereinafter, the range of the radio waves is referred to as “communication area”. Therefore, a sensor node 101-1 far away from the parent node 102 relays and transfers data via other sensor nodes 101-2.

In this case, the sensor nodes 101 may stop the supply of electric power to an internal microprocessor (micro control unit (MCU)) to reduce power consumption. For this reason, a sensor node 101 as a data sender sends a startup instruction to another sensor node and, after the other sensor node has completed preparation for data reception, sends data thereto by radio waves. Through this relay transfer, each sensor node 101 delivers detection data to the parent node 102 (see arrows in FIG. 1).

With reference to FIG. 1, description will be given of the flow of data sent by a sensor node 101-1 when the sensor node 101-1 is a data sender. (1) First, a sensor node 101-1 sends a startup instruction to a communication area to which the sensor node 101-1 belongs. Thereby, the sensor node 101-1 causes another sensor node 101 (the sensor node 101-2 in the example depicted in FIG. 1) within the communication area of the sensor node 101-1 to receive the startup instruction to start preparation for data reception.

(2) The sensor node 101-1 then waits for a predetermined standby period to elapse, irrespective of a response to the startup instruction from the other sensor node 101. The predetermined standby period is equivalent to the longest startup period of the sensor node 101 consequent to manufacturing deviance. The predetermined standby period is stored, for example, in ROM included in the sensor node 101-1. Thereby, the sensor node 101-1 waits for the other sensor node 101 in the communication area to complete preparation for data reception.

(3) Meanwhile, upon receiving the startup instruction, the sensor node 101-2 starts up the MCU included in the sensor node 101-2 and measures the startup period of the MCU. The startup period is a period from the reception of the startup instruction until completion of preparation for data reception by the MCU. In this case, the sensor node 101-2 need not return a response to the startup instruction to the sensor node 101-1.

(4) Thereafter, when the predetermined standby period has elapsed, the sensor node 101-1 sends data within the communication area to which the sensor node 101-1 belongs. Thereby, the sensor node 101-1 causes the other sensor node 101 (the sensor node 101-2 in the example depicted in FIG. 1) within the communication area of the sensor node 101-1 to receive the data.

(5) Meanwhile, upon receiving the data, the sensor node 101-2 sends to the sensor node 101-1, data that includes information indicating the startup period of the MCU of the sensor node 101-2, as a response to the received data.

(6) Next, upon receiving the response sent at (5), the sensor node 101-1 extracts from the received response, the information indicating the startup period of the MCU of the sensor node 101-2. Then, using the startup period of the MCU of the sensor node 101-2 indicated by the extracted information, the sensor node 101-1 shortens the standby period from the longest startup period. The shortened standby period is stored, for example, in non-volatile memory in the sensor node 101-1.

Subsequently, similar to (1), (2), and (4), the sensor node 101-1 sends a startup instruction to the sensor node 101-2 and, when the shortened standby period stored in the non-volatile memory has elapsed, sends data to the sensor node 101-2. In this manner, the sensor node 101-1 can send data immediately after the sensor node 101-2 has completed preparation for reception, so that the standby period can be shortened. Shortening the standby period enables the sensor node 101-1 to reduce power consumption.

Since the sensor node 101-2 need not send a response to the startup instruction, the sensor node 101-2 can reduce the power consumed for sending of the response. If the sensor node 101-2 does not send a response, the amount of communication in the sensor network 100 can be reduced and the communication can be prevented from becoming congested. By reducing the standby period, the sensor node 101-1 can shorten the processing time for an event that has occurred.

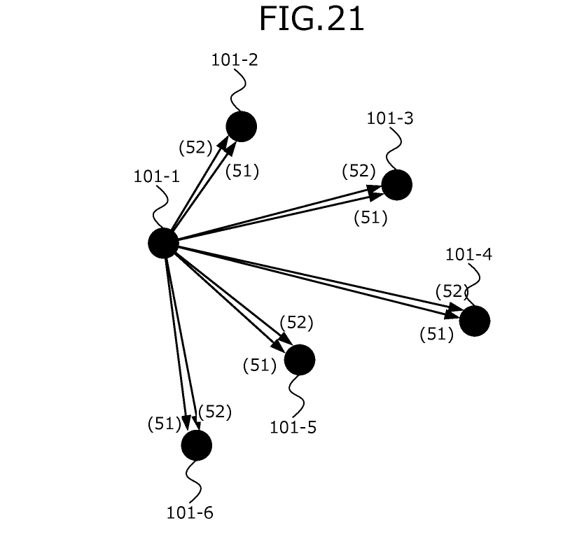

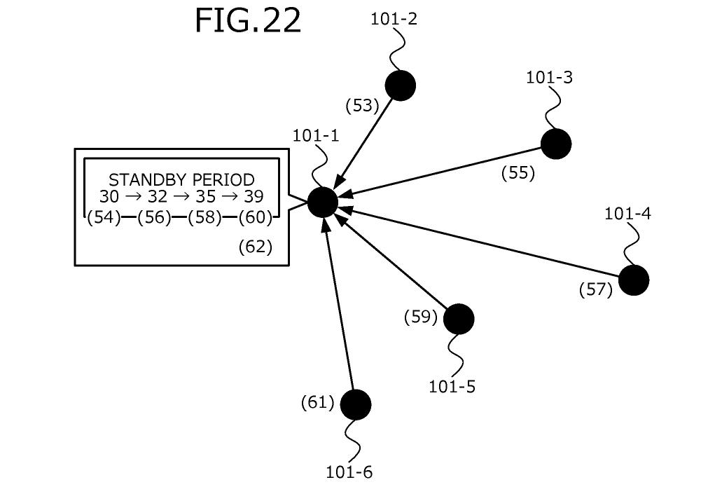

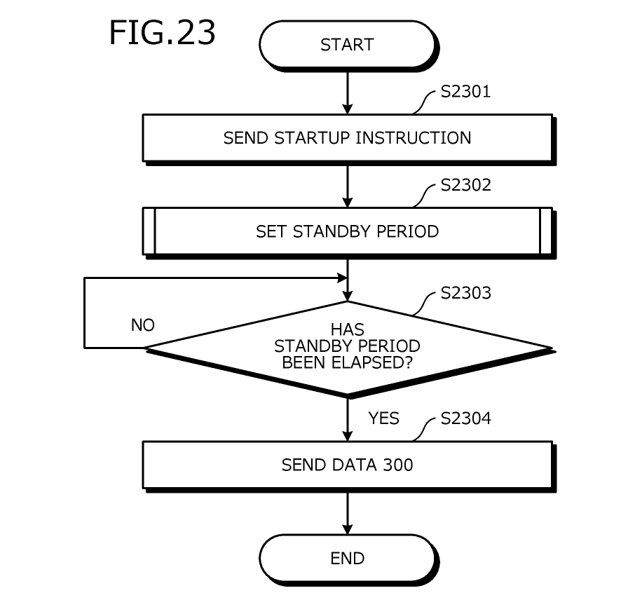

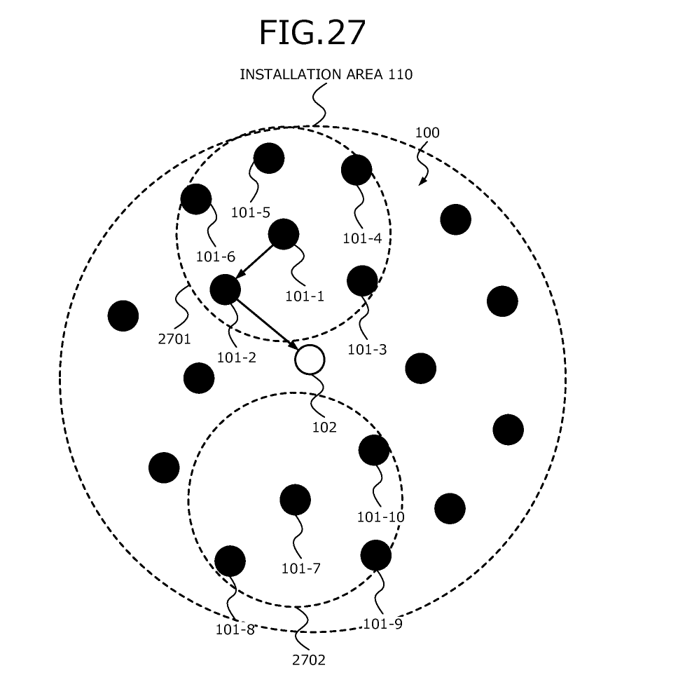

In the case of reception of plural responses, the sensor node 101-1 may shorten the standby period using the longest startup period among startup periods indicated by information included in the plural responses. A case of shortening the standby period using the longest startup period will be described later with reference to FIGS. 21 and 22. In the case of reception of plural responses, the sensor node 101-1 may shorten the standby period using an x-th shortest startup period among startup periods indicated by information included in the plural responses. A case of shortening the standby period using the x-th shortest startup period will be described later with reference to FIGS. 27 to 29.

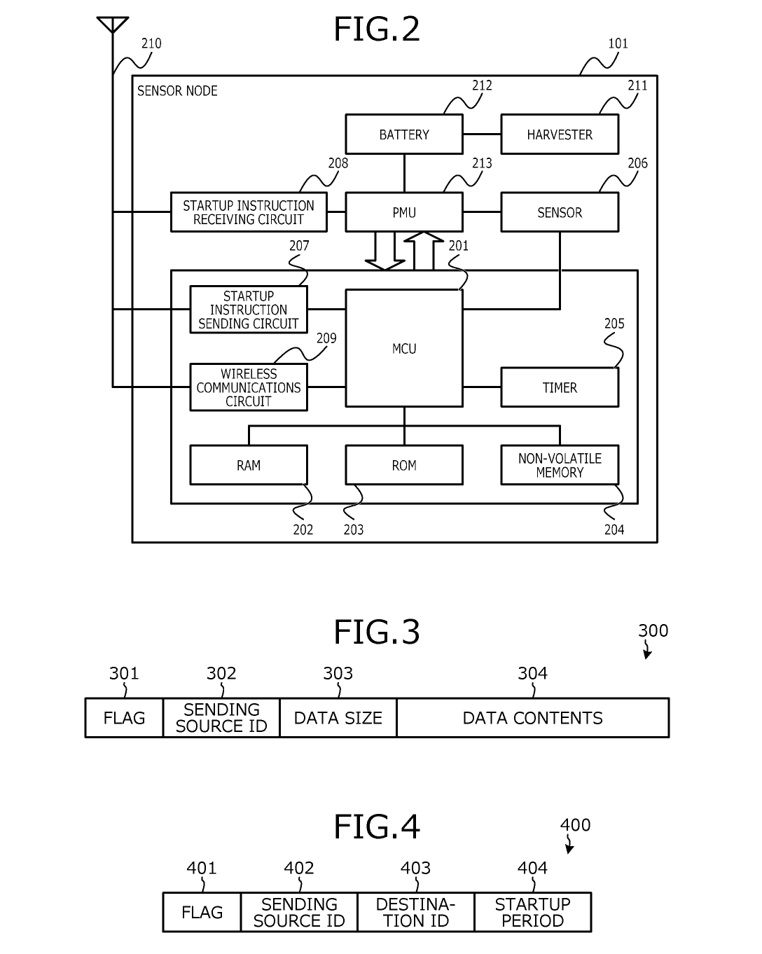

With reference to FIG. 2, an internal configuration example of the sensor node 101 depicted in FIG. 1 will be described.

FIG. 2 is a block diagram of an internal configuration example of the sensor node 101. The sensor node 101 includes an MCU 201, random access memory (RAM) 202, read only memory (ROM) 203, non-volatile memory 204, a timer 205, and a sensor 206. The sensor node 101 includes a startup instruction sending circuit 207, a startup instruction receiving circuit 208, a wireless communications circuit 209, and an antenna 210. The sensor node 101 includes a harvester 211, a battery 212, and a power management unit (PMU) 213.

The MCU 201 provides overall control of the sensor node 201. The MCU 201 is connected via signal lines to the RAM 202, the ROM 203, the non-volatile memory 204, the timer 205, the startup instruction sending circuit 207, the wireless communications circuit 209, and the sensor 206.

The RAM 202 stores transient data of processes performed in the MCU 201. The RAM 202 is connected via a signal line to the MCU 201. The ROM 203 stores processing programs (e.g., a communications program), etc. to be executed by the MCU 201. The ROM 203 may store a standby period based on the longest startup period that is consequent to manufacturing deviance of the sensor node 101. The ROM 203 is connected via a signal line to the MCU 201.

The non-volatile memory stores data written thereto even when the power supply is interrupted, for example. The non-volatile memory 204 may store a standby period based on the startup period of another sensor node 101. The non-volatile memory 204 is connected via a signal line to the MCU 201.

The timer 205 counts a pulse signal generated by a clock (CLK), to measure the elapsed time. The timer 205 is connected via a signal line to the MCU 201. The sensor 206 detects a given displacement at the installation site. The sensor 206 may be, for example, a piezoelectric element that detects a pressure at the installation site or a photoelectric element that detects light. The sensor 206 causes an event, based on the detected displacement. The sensor 206 is connected via signal lines to the MCU 201 and PMU 213.

The startup instruction receiving circuit 208 receives a startup instruction via the antenna 210, and sends the startup instruction to the PMU 213. The startup instruction is to a radio wave of a predetermined frequency activating another sensor node 101. The startup instruction receiving circuit 208 is, for example, a circuit that detects only a radio wave of the predetermined frequency acting as a startup instruction. The predetermined frequency is determined by, for example, a developer of the sensor network 100.

The startup instruction sending circuit 207 sends a startup instruction via the antenna 210. The startup instruction sending circuit 207 is, for example, a circuit that sends, via the antenna 210, only a radio wave of the predetermined frequency acting as the startup instruction. Unlike the wireless communications circuit 209 that will be described later, the startup instruction receiving circuit 208 and the startup instruction sending circuit 207 handle only a radio wave of the predetermined frequency and therefore, has a lower power consumption than that of the wireless communications circuit 209.

The wireless communications circuit (radio frequency (RF)) 209 outputs to the MCU 201, a radio wave received via the antenna 210, as a reception signal. The wireless communications circuit 209 sends a send signal in the form of a radio wave via the antenna 210. Unlike the startup instruction receiving circuit 208 and the startup instruction sending circuit 207, the wireless communications circuit 209 is a circuit that sends or receives a radio wave of a predetermined frequency bandwidth. Since the wireless communications circuit 209 has a wider radio wave frequency bandwidth than the startup instruction receiving circuit 208 and the startup instruction sending circuit 207, the wireless communications circuit 209 consumes more power than the startup instruction receiving circuit 208 and the startup instruction sending circuit 207.

The antenna 210 sends or receives a radio wave. In this case, the antenna 210 is shared by the startup instruction receiving circuit 208, the startup instruction sending circuit 207, and the wireless communications circuit 209, however, configuration is not limited hereto. For example, the sensor node 101 may have antennas specific to the startup instruction receiving circuit 208, the startup instruction sending circuit 207, and the wireless communications circuit 209, respectively.

The harvester 211 generates power, based on an energy changes such as variations in light, oscillation, temperature, radio wave (reception radio wave), etc., for example, at the installation site of the sensor node 101. The battery 212 accumulates a power generated by the harvester 211. The PMU 213 supplies the power accumulated in the battery 212 as a drive power source for components of the sensor node 101. In other words, the sensor node 101 does not need a secondary battery, an external power source, etc., and internally generates the power required for the operations of the sensor node 101.

The amount of power that can be accumulated in the battery 212 is limited and therefore, the sensor node 101 may, for example, suspend the power supply to the MCU 201, the ROM 203, etc., until the occurrence of an event, so as to reduce power consumption. For example, the sensor node 101 suspends the power supply to the MCU 201, the RAM 202, the ROM 203, the non-volatile memory 204, the timer 205, the startup instruction sending circuit 207, and the wireless communications circuit 209.

In this case, the sensor node 101 maintains the power supply to the startup instruction receiving circuit 208 and to the sensor 206 that generates a trigger to start the power supply to the MCU 201, the ROM 203, etc. The sensor 206 is operable by the electromotive force generated by the sensor 206 itself and may be operable without power supply from the PMU 213. In the same manner, the startup instruction receiving circuit 208 is operable by the electromotive force generated at the antenna 210 and may be operable without power supply from the PMU 213.

With reference to FIGS. 3 and 4, an example will be described of a signal sent from or received by the wireless communications circuit 209. The signal sent from or received by the wireless communications circuit 209 can be, for example, data indicating a detection result of the sensor 206 or a response to the data indicating the detection result of the sensor 206.

FIG. 3 is an explanatory view of an example of data indicating a detection result of the sensor 206. As depicted in FIG. 3, data 300 includes a flag (reference numeral 301), a sending source ID (reference numeral 302), a data size (reference numeral 303), and a data content (reference numeral 304).

The flag is information for identifying whether a signal including the flag is the data 300 sent from a sending source or a response for the data 300. For example, the flag is “0” when the signal including the flag is the data 300 sent from the sending source. The sending source ID is an identifier of the sensor node 101 that is the signal sending source. The data size is a bit length or a byte length of the data contents. The data content is the contents of the data 300 and is, for example, a detection result of the sensor 206.

FIG. 4 is an explanatory view of an example of a response for the data 300. As depicted in FIG. 4, a response 400 includes a flag (reference numeral 401), a sending source ID (reference numeral 402), a destination ID (reference numeral 403), and a startup period (numeral 404).

The flag is information for identifying whether a signal including the flag is the data 300 sent from a sending source or a response for the data 300. For example, the flag is “1” when the signal including the flag is a response for the data 300. The sending source ID is an identifier of the sensor node 101 that is the signal sending source. The destination ID is an identifier of the sensor node 101 that is a sending source of the data 300 and is a destination of the response 400. The startup period is information indicating the startup period of the sensor node 101 that sends the response 400.

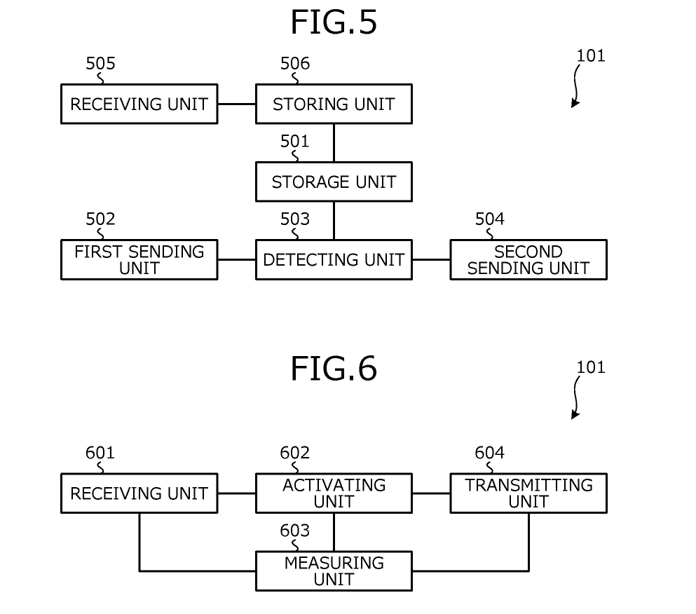

With reference to FIGS. 5 and 6, description will be given of a functional configuration example of the sensor node 101 functioning as a communications apparatus. Hereinafter, the function as the sending-side communications apparatus and the function as the receiving-side communications apparatus are separately described, but the sensor node 101 may have both the function as the sending-side communications apparatus and the function as the receiving-side communications apparatus.

FIG. 5 is a block diagram of a functional configuration example of the sensor node 101 functioning as the sending-side communications apparatus. The sending-side sensor node 101 includes a storage unit 501, a first sending unit 502, a detecting unit 503, a second sending unit 504, a receiving unit 505, and a storing unit 506.

The storage unit 501 stores therein a standby period not less than the longest startup period of another communications apparatus, before the receiving unit 505 receives information indicating time taken for the startup of the other communications apparatus. In this case, the communications apparatus refers, for example, to the sensor node 101. The time taken for the startup refers to the time until the completion of preparation for data reception after a startup instruction is received by the sensor node 101, and, for example, refers to the above startup period. The standby period refers to a time not less than the startup period required for the reception process of the data 300 becoming possible after the other sensor node 101 starts up the MCU 201. The longest startup period refers, for example, to a longest startup period consequent to manufacturing deviations of the sensor node 101.

This enables the detecting unit 503 to detect the elapse of the standby period before the completion of preparation for reception of the data 300 after another sensor node 101 in the communication area has completed the startup of the MCU 201 of the other sensor node 101. The function of the storage unit 501 is realized by storage devices such as a register in the MCU 201 depicted in FIG. 2, the ROM 203, the RAM 202, and the non-volatile memory 204, for example.

The first sending unit 502 sends a startup instruction within the communication area. As described above, the startup instruction is a radio wave of a predetermined frequency to activate another sensor node 101 and is a radio wave of a frequency that is receivable by the startup instruction receiving circuit 208 of the sensor node 101. This enables the first sending unit 502 to give another sensor node 101 in the communication area a trigger to activate the MCU 201 of the other sensor node 101. The function of the first sending unit 502 is realized, for example, by the startup instruction sending circuit 207 and by causing the MCU 201 to execute a program stored in a storage device such as the ROM 203, the RAM 202, and the non-volatile memory 204 depicted in FIG. 2.

The detecting unit 503 detects the elapse of the standby period stored in the storage unit 501, after the sending of a startup instruction from the first sending unit 502. At the point in time when the startup instruction is sent from the first sending unit 502, for example, the detecting unit 503 acquires the elapsed time to be measured by the timer 205. The detecting unit 503 then monitors the elapsed time measured by the timer 205 and detects the elapse of the standby period when the elapsed time measured by the timer 205 reaches and exceeds the sum of the acquired elapsed time and the standby period.

Thereby, the detecting unit 503 can detect that another sensor node 101 in the communication area has started up the MCU 210 of the other sensor node 101 and is ready for the reception of the data 300. The function of the detecting unit 503 is realized, for example, by the timer 205 and by causing the MCU 201 to execute a program stored in a storage device such as the ROM 203, the RAM 202, and the non-volatile memory 204 depicted in FIG. 2.

The second sending unit 504 sends the data 300 in the communication area when the detecting unit 503 detects the elapse of the standby period. This enables the other sensor nodes 101 in the communication area to receive the data 300 sent from the second sending unit 504. The function of the second sending unit 504 is realized, for example, by the wireless communications circuit 209 and by causing the MCU 201 to execute a program stored in a storage device such as the ROM 203, the RAM 202, and the non-volatile memory 204 depicted in FIG. 2.

When sending a startup instruction to activate another communications apparatus in the communication area, the receiving unit 505 receives from the other communications apparatus, information indicating the time consumed for the startup of the other communications apparatus. The receiving unit 505 receives, for example, the response 400 depicted in FIG. 4 and extracts a startup period from a region indicated by reference numeral 404 of the response 400.

This enables the storing unit 506 to adjust the standby period using the startup period of another sensor node 101 in the communication area. The function of the receiving unit is realized, for example, by the wireless communications circuit 209 and by causing the MCU 201 to execute a program stored in a storage device such as the ROM 203, the RAM 202, and the non-volatile memory 204 depicted in FIG. 2.

The storing unit 506 stores into the storage unit 501, a standby period based on the time indicated by the information received by the receiving unit 505. The storing unit 506 stores into the storage unit 501, the startup period extracted from the response 400 by the receiving unit 505, for example, as the standby period. This enables the storing unit 506 to employ, as the standby period, a startup period that is of another sensor node 101 and shorter than the longest startup period consequent to manufacturing deviations of the sensor node 101, to thereby shorten the standby period. Even though the standby period is shortened, the detecting unit 503 can wait until another sensor node 101 becomes ready for the data reception.

For example, the storing unit 506 may store, as the standby period, into the storage unit 501, the sum of a startup period extracted from the response 400 by the receiving unit 505 and a predetermined time to allow for a change in the startup period arising from deterioration with age, etc. This enables the detecting unit 503 to wait until another sensor node 101 becomes ready for the data reception even in a case where the startup period of the other sensor node 101 becomes longer due to deterioration with age, etc.

In a case where the receiving unit 505 receives information from other communications apparatuses in plural, the storing unit 506 may store into the storage unit 501, a standby period based on the longest period among plural times indicated by the received information. This enables the second sending unit 504 to send the data 300 after the startup of all of the sensor nodes 101 within the communication area.

In a case where the receiving unit 505 receives information from other communications apparatuses in plural, the storing unit 506 may store into the storage unit 501, a standby period based on the x-th shortest period among periods indicated by the received information. In this case, the x-th refers for example to an ordinal in the number of the sensor nodes 101 used in the configuration of the sensor network 100. The number of the sensor nodes 101 used in the configuration of the sensor network 100 is decided by the developer of the sensor network 100, for example.

This enables the second sending unit 504 to send the data 300 at the point of time of startup of the number of the sensor nodes 101 used in the configuration of the sensor network 100 among the sensor nodes 101 within the communication area. Accordingly, the storing unit 506 can shorten the standby period.

In a case where the number of the responses 400 from other communications apparatuses to the data 300 sent from the second sending unit 504 is not more than a predetermined number, the storing unit 506 may extend the standby period stored in the storage unit 501. The predetermined number is, for example, the number of the sensor nodes 101 used in the configuration of the sensor network 100. The predetermined number is decided by the developer of the sensor network 100, for example. The predetermined number may be the number of the sensor nodes 101 that have most recently performed communication of the data 300 and may be variable.

This enables the sensor node 101 to extend the standby period in a case where the second sending unit 504 has unintentionally sent the data 300 before the startup of the sensor nodes 101 within the communication area. The function of the storing unit 506 is realized, for example, by causing the MCU 201 to execute a program stored in a storage device such as the ROM 203, the RAM 202, and the non-volatile memory 204 depicted in FIG. 2.

Subsequently, the sending-side sensor node 101 sends data using the standby period stored to the storage unit 501 by the storing unit 506. This enables the sending-side sensor node 101 to send data using a proper standby period for another sensor node 101 within the communication area to become ready for the reception of the data 300. Thus, the sending-side sensor node 101 can reduce the power consumed by reducing the standby period.

FIG. 6 is a block diagram of a functional configuration example of the sensor node 101 functioning as a receiving-side communications apparatus. The receiving-side sensor node 101 includes a receiving unit 601, an activating unit 602, a measuring unit 603, and a sending unit 604.

The receiving unit 601 receives a startup instruction from a sending source that sends the data 300 after the elapse of a predetermined standby period from the sending of the startup instruction. The sending source is a communications apparatus having the above sending-side function and is, for example, the sensor node 101. The receiving unit 601 receives a startup instruction from another sensor node 101, for example. This enables the activating unit 602 to acquire a trigger to activate a processor. The function of the receiving unit 601 is realized by, for example, the startup instruction receiving circuit 208 depicted in FIG. 2.

The activating unit 602 activates a processor within the apparatus when the receiving unit 601 receives a startup instruction. The processor is an apparatus executing the reception process of the data 300 and is, for example, the MCU 201 of the sensor node 101. The activating unit 602 sends to the PMU 213, a request to start the power supply to the MCU 201, for example, when the receiving unit 601 receives the startup instruction. This allows the MCU 201 to be activated. The function of the activating unit 602 is realized by the startup instruction receiving circuit 208 and the PMU 213 depicted in FIG. 2, for example.

The measuring unit 603 measures the time consumed for the reception process of the data 300 by the processor activated by the activating unit 602 becoming possible after the reception of the startup instruction by the receiving unit 601. The time consumed for the reception process of the data 300 by the processor activated by the activating unit 602 to become possible after the reception of the startup instruction by the receiving unit 601 is the above startup period, for example.

This enables the measuring unit 603 to acquire the actual startup period. The function of the measuring unit 603 is realized, for example, by the timer 205 and by causing the MCU 201 to execute a program stored in a storage device such as the ROM 203, the RAM 202, and the non-volatile memory 204 depicted in FIG. 2.

The sending unit 604 sends information indicating a time measured by the measuring unit 603 to the sending source. For example, the sending unit 604 sends the response 400 of FIG. 4 including the startup period of the apparatus to a sensor node 101 having the sending-side function.

This enables the sending-side sensor node 101 to adjust the standby period by the receiving unit 505 and the storing unit 506. The function of the sending unit 604 is realized, for example, by the wireless communications circuit 209 and by causing the MCU 201 to execute a program stored in a storage device such as the ROM 203, the RAM 202, and the non-volatile memory 204 depicted in FIG. 2.

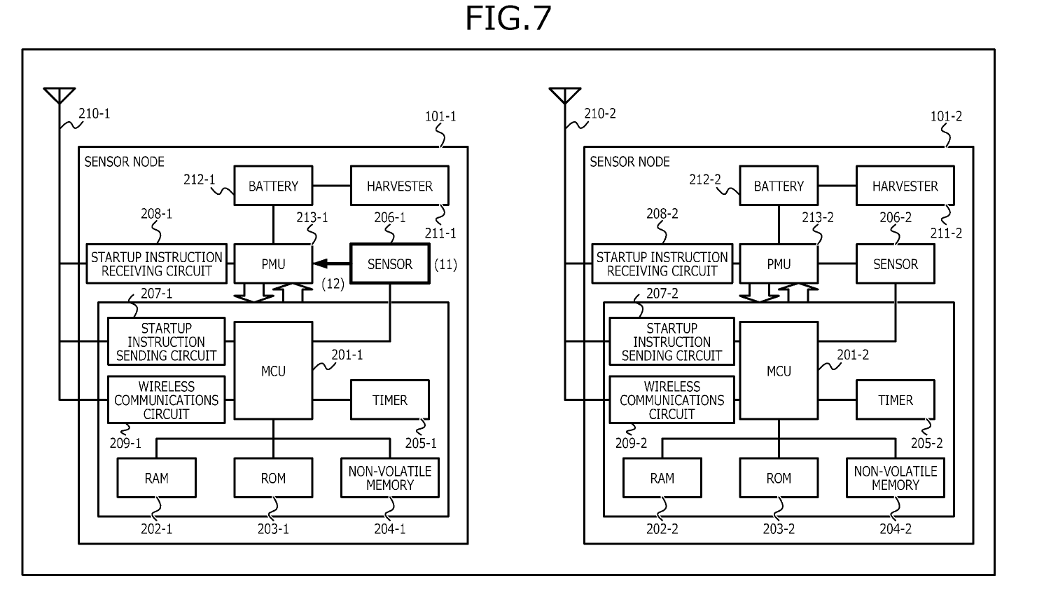

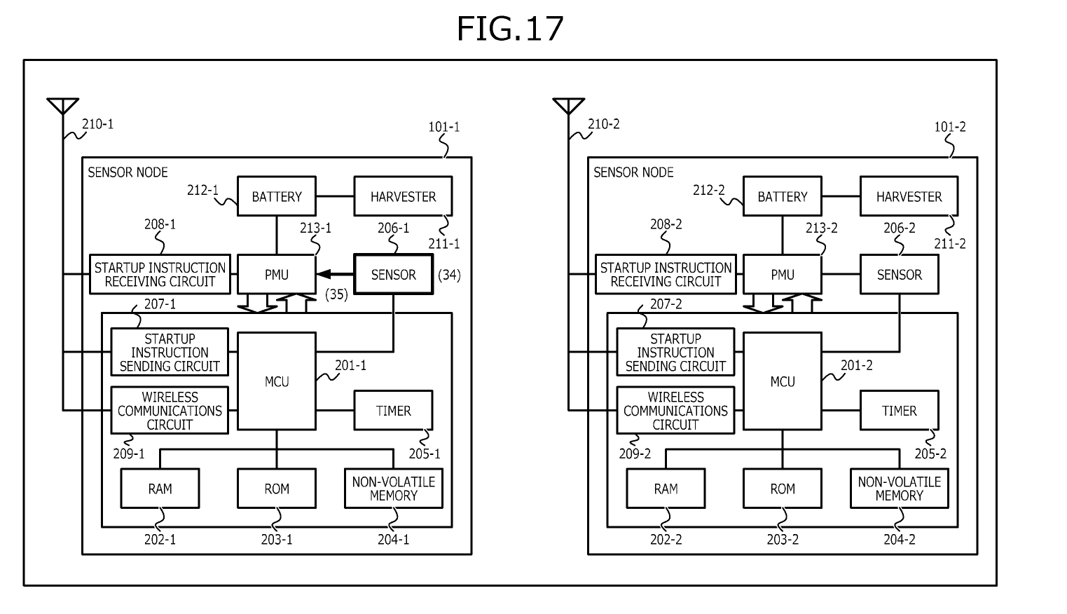

With reference to FIGS. 7 to 20, examples of communication between the sensor nodes 101 will be described. FIGS. 7, 8, 9, 10, 11, 12, 13, 14, 15, and 16 are explanatory views of an example of first communication between the sensor nodes 101. FIGS. 17, 18, 19, and 20 are explanatory views of examples of second and subsequent communications between the sensor nodes 101. In FIGS. 7 to 20, the sensor node 101-1 is a communications apparatus having a sending-side function and the sensor node 101-2 is a communications apparatus having a receiving-side function. In FIGS. 7 to 20, it is assumed that the sensor nodes 101-1 and 101-2 lie within the same communication area.

Hereinafter, regarding the internal configuration of the sensor node 101 of FIG. 2, a suffix “−1” is given to the sensor node 101-1 side and a suffix “−2” is given to the sensor node 101-2 side, to thereby identify them from each other. For example, an MCU 201-1 represents an MCU 201 of the sensor node 101-1 and an MCU 201-2 represents an MCU 201 of the sensor node 101-2.

With reference to FIGS. 7 to 16, the first communication example will be described. In this case, the sensor node 101-1 is assumed to stop the power supply to the MCU 201-1, ROM 203-1, etc. Similarly, the sensor node 101-2 is assumed to stop the power supply to the MCU 201-2, ROM 203-2, etc.

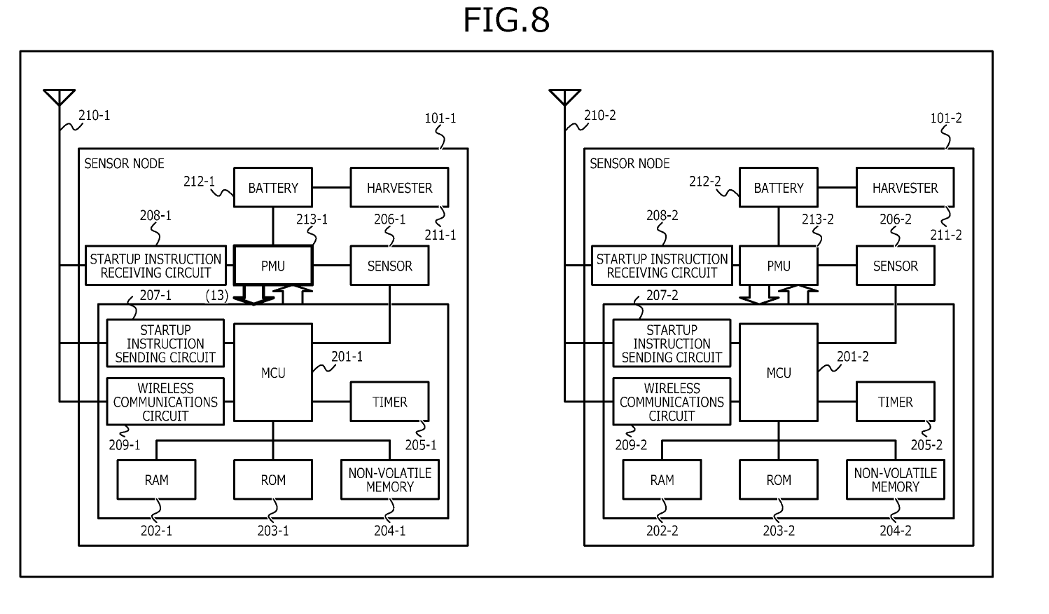

In FIG. 7, (11) a sensor 206-1 detects a given displacement and generates an event. For example, the sensor 206-1 generates an event when the detected temperature exceeds a threshold value. (12) When the event occurs, the sensor 206-1 sends a request to start the power supply to a PMU 213-1. Description will be given with reference to FIG. 8.

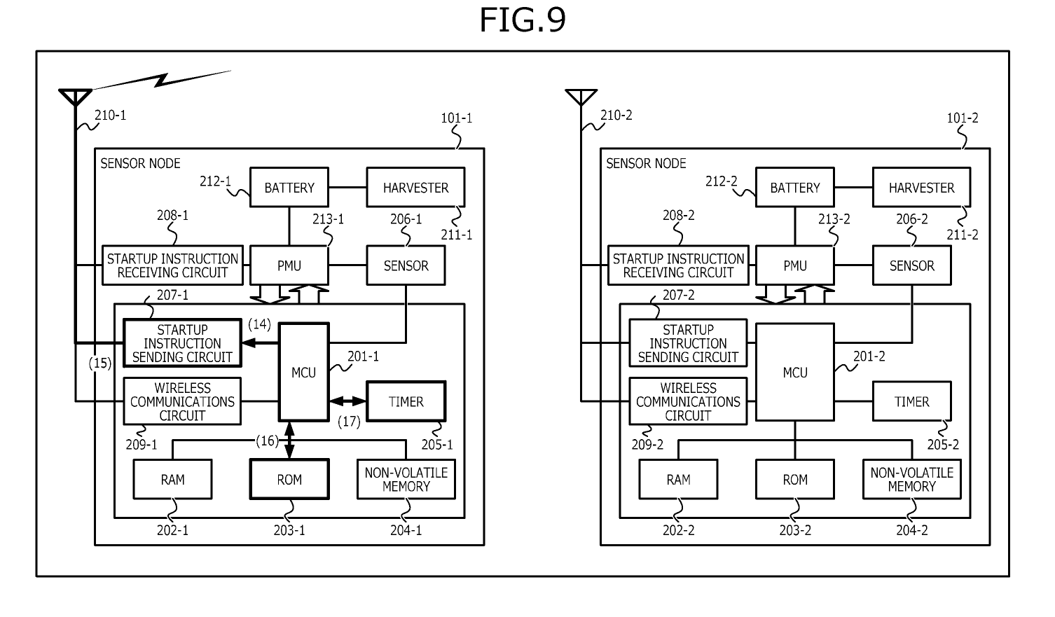

In FIG. 8, (13) when receiving the request to start the power supply, the PMU 213-1 starts the power supply to the MCU 201, the ROM 203-1, etc. As a result, the MCU 201-1 starts activation. A timer 205-1 starts the measurement of the elapsed time. Description will be given with reference to FIG. 9.

In FIG. 9, when the MCU 201-1 becomes activated and ready for the reception of the data 300, the MCU 201-1 executes a process corresponding to the event that has occurred. In this case, the MCU 201-1 relays the process result to the parent node 102 via other sensor nodes 101 within the communication area.

(14) Thus, the MCU 201-1 sends to a startup instruction sending circuit 207-1, a request to send a startup instruction to start up the sensor nodes 101 within the communication area. (15) When receiving the send request, the startup instruction sending circuit 207-1 sends the startup instruction within the communication area via an antenna 210-1.

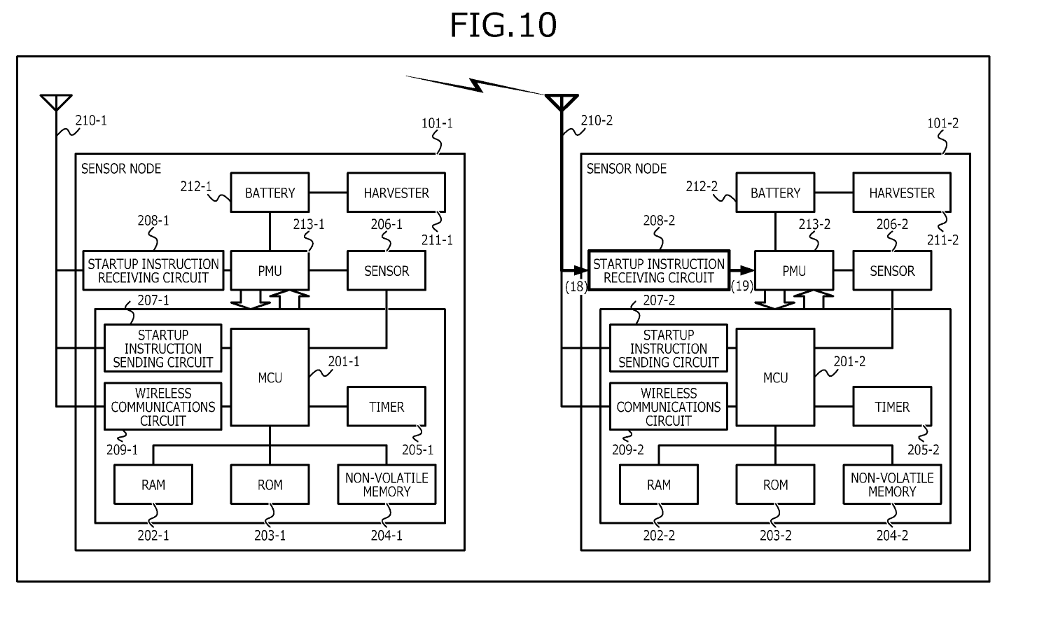

(16) When sending the send request, the MCU 201-1 reads from the ROM 203-1, a standby period that is the longest startup period consequent to manufacturing deviations of the sensor node 101. (17) The MCU 201-1 acquires the elapsed time at the point of sending of the send request from the timer 205-1. Description will be given with reference to FIG. 10.

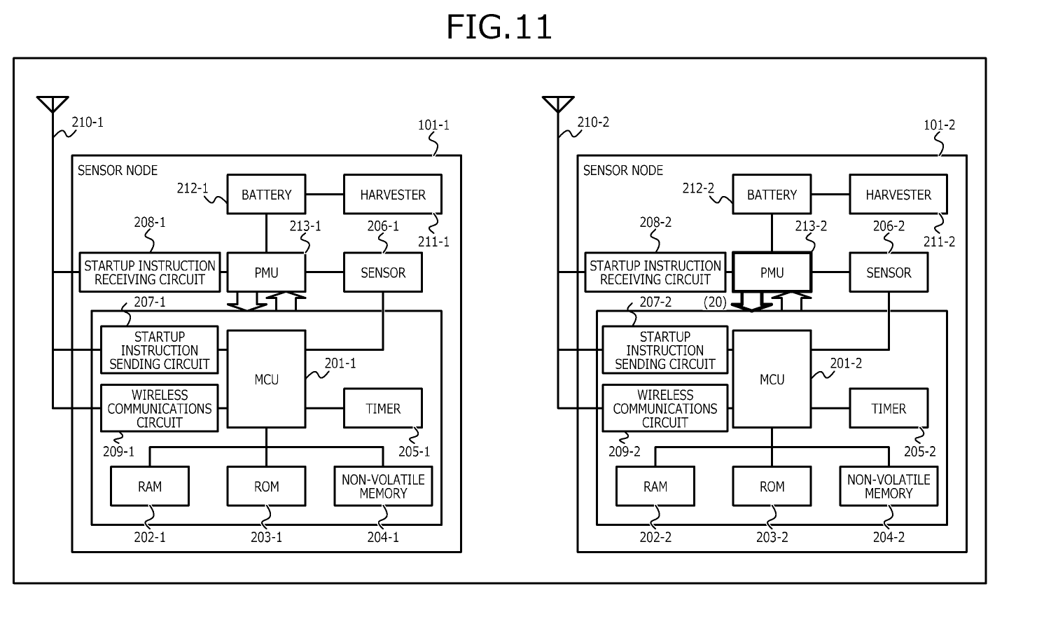

In FIG. 10, (18) a startup instruction receiving circuit 208-2 receives a startup instruction sent from the sensor node 101-1 via an antenna 210-2. (19) When receiving the startup instruction, the startup instruction receiving circuit 208-2 sends to a PMU 213-2, a request to start the power supply. Description will be given with reference to FIG. 11.

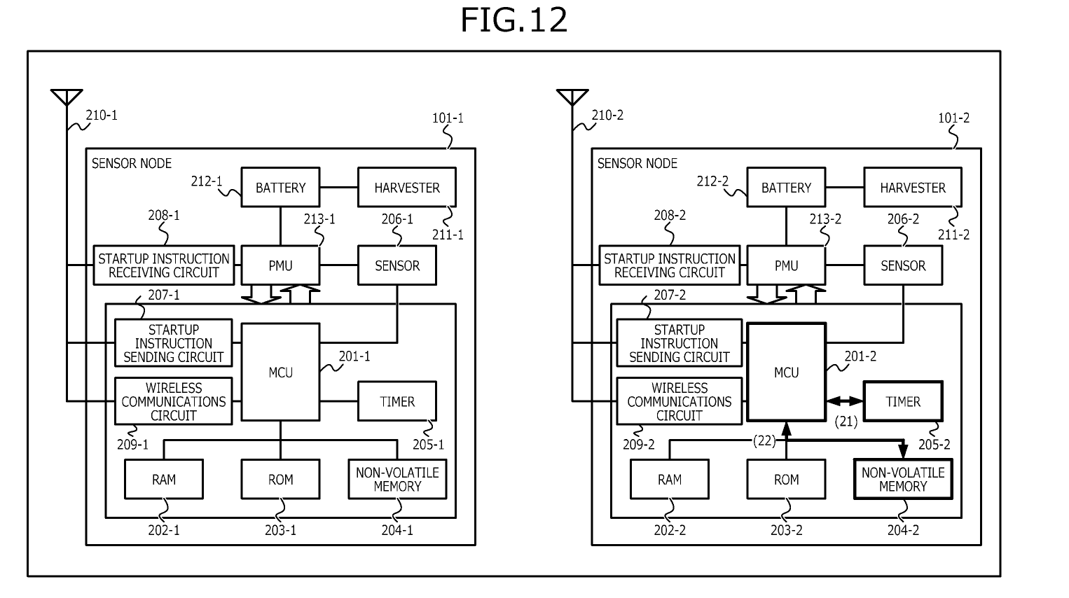

In FIG. 11, (20) when receiving the request to start the power supply, the PMU 213-2 starts the power supply to the MCU 201-2, the ROM 203-2, etc. As a result, the MCU 201-2 starts activation. A timer 205-2 starts the measurement of the elapsed time. Description will be given with reference to FIG. 12.

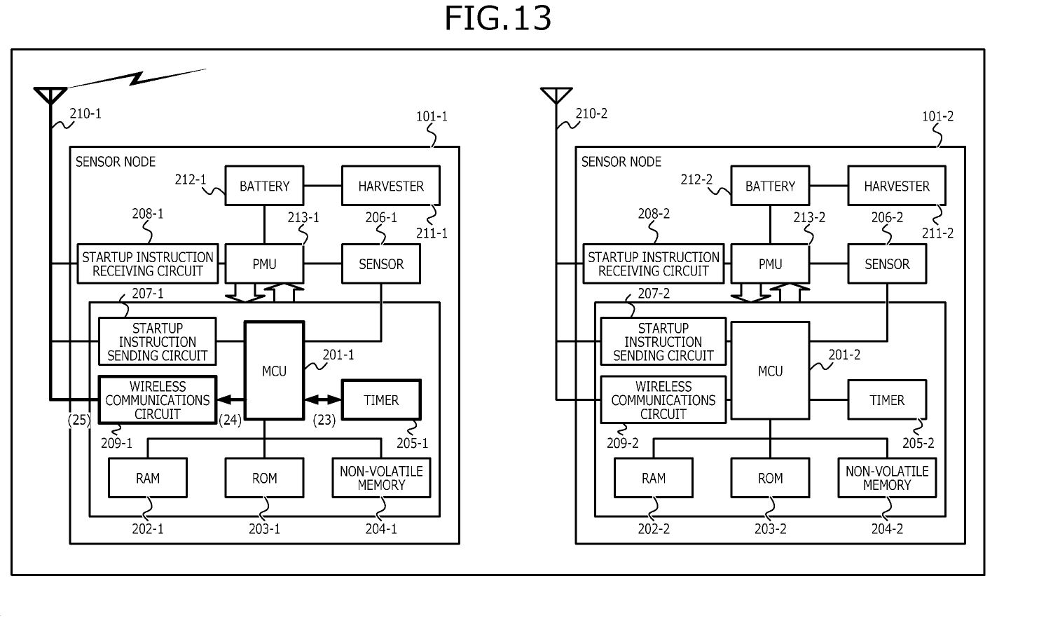

In FIG. 12, (21), at the point of time when the activation is completed, the MCU 201-2 acquires the elapsed time measured by a timer 205-2. (22) The MCU 201-2 then stores to non-volatile memory 204-2, the measured elapsed time as the startup period of the MCU 201-2. Description will be given with reference to FIG. 13.

In FIG. 13, (23) the MCU 201-2 acquires the elapsed time measured by the timer 205-1. Using the acquired elapsed time and the elapsed time at the point of time of sending of the send request acquired at (17), the MCU 201-1 then determines whether the standby period read at (16) has elapsed. In this example, it is assumed that the standby period has elapsed.

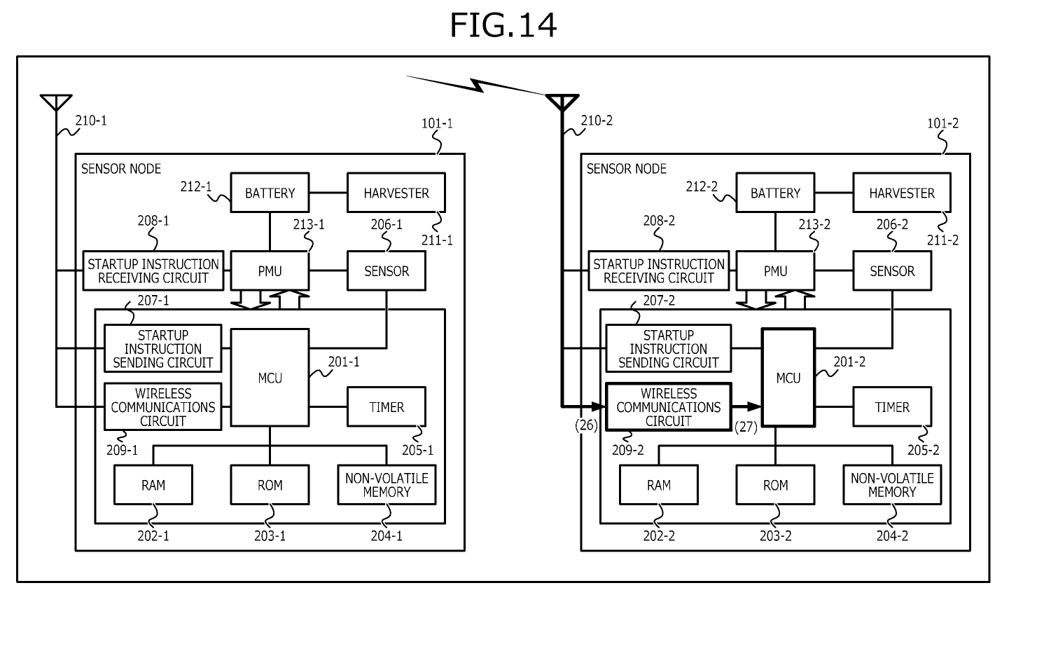

(24) Upon determining that the standby period has elapsed, the MCU 201-1 sends a request to send a process result to a wireless communications circuit 209-1. (25) When receiving the send request, the wireless communications circuit 209-1 sends the process result within the communication area via the antenna 210-1. Description will be given with reference to FIG. 14.

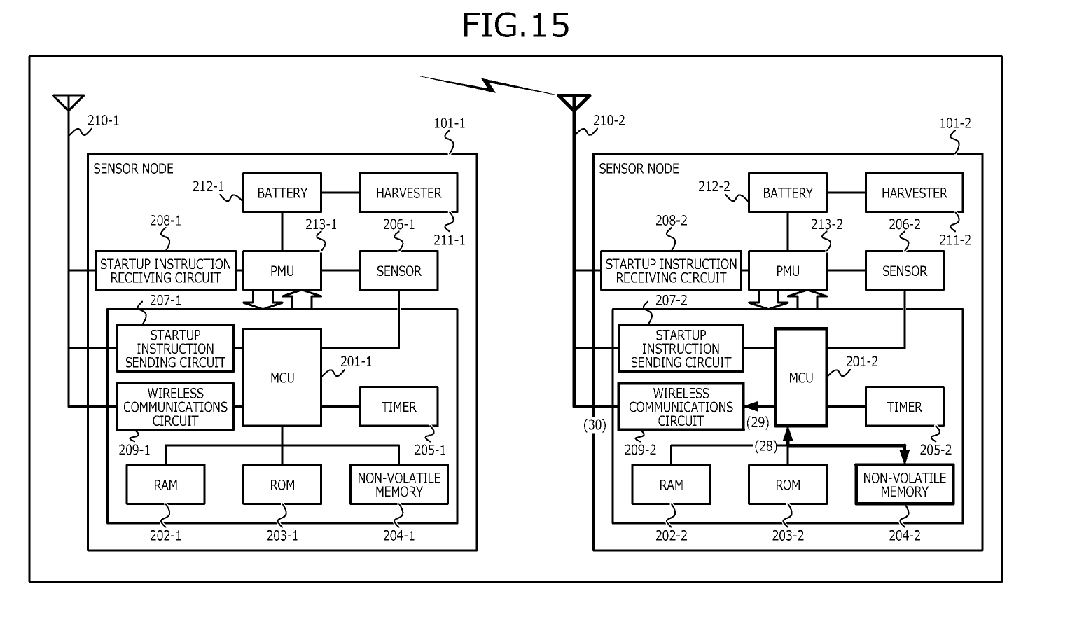

In FIG. 14, (26) a wireless communications circuit 209-2 receives, via the antenna 210-2, the process result sent from the sensor node 101-1. (27) When receiving the process result, the wireless communications circuit 209-2 sends the process result to the MCU 201-2. Description will be given with reference to FIG. 15.

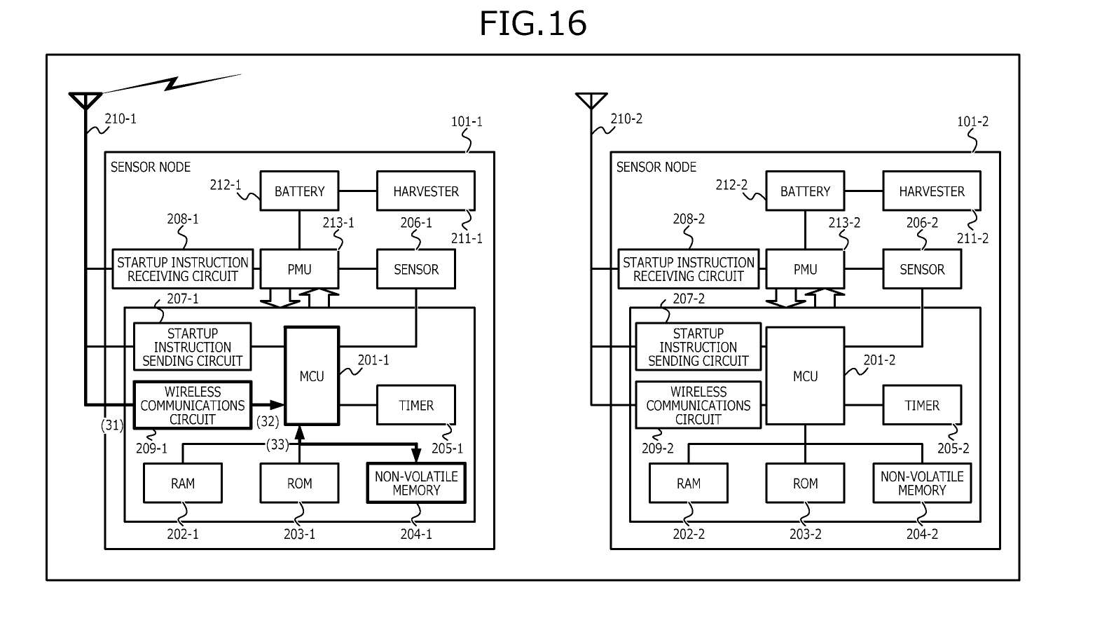

In FIG. 15, (28) when receiving the process result, the MCU 201-2 reads from the non-volatile memory 204-2, the startup period of the MCU 201-2 stored at (22). (29) The MCU 201-2 then generates a response 400 including the read startup period of the MCU 201-2. The MCU 201-2 sends a request to send the generated response 400 to the wireless communications circuit 209-2. (30) When receiving the send request, the wireless communications circuit 209-2 sends the response 400 in the communication area via the antenna 210-2. Description will be given with reference to FIG. 16.

In FIG. 16, (31) the wireless communications circuit 209-1 receives, via the antenna 210-1, the response 400 sent from the sensor node 101-2. (32) When receiving the response 400, the wireless communications circuit 209-1 sends the response 400 to the MCU 201-1.

(33) When receiving the response 400, the MCU 201-1 extracts the startup period of the MCU 201-2 from the response 400. The MCU 201-1 then retains the extracted startup period as a new standby period in non-volatile memory 204-1. In this manner, the sensor node 101 allows another sensor node 101 within the communication area to receive the data 300, to perform communication of the data 300. The case of receiving plural responses at (31) will be described later with reference to FIGS. 21 and 22 or with reference to FIGS. 27 to 29.

Thereafter, when the communication of the data 300 ends, the sensor node 101-1 stops the power supply to the MCU 201-1, the ROM 203-1, etc. Similarly, when the communication of the data 300 ends, the sensor node 101-2 stops the power supply to the MCU 201-2, the ROM 203-2, etc. This enables the sensor node 101 to reduce power consumption.

With reference to FIGS. 17 to 20, the second and subsequent communication examples will be described. In this case, the sensor node 101-1 is assumed to suspend the power supply to the MCU 201-1, the ROM 203-1, etc. Similarly, the sensor node 101-2 is assumed to suspend the power supply to the MCU 201-2, the ROM 203-2, etc.

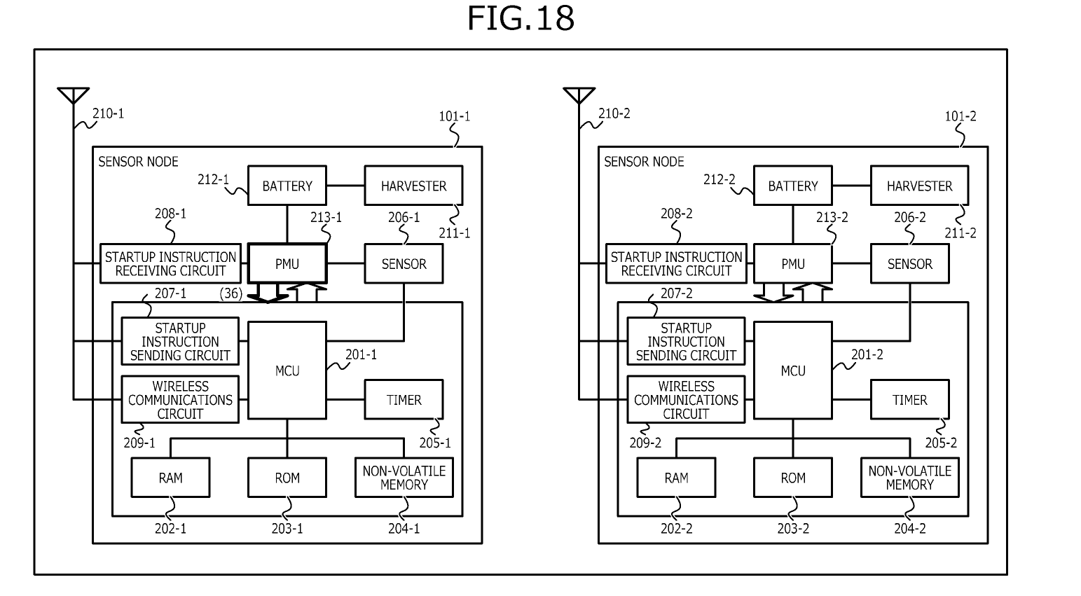

In FIG. 17, (34) the sensor 206-1 is assumed to generate an event, similar to (11). (35) When the event occurs, the sensor 206-1 sends a request to start the power supply to a PMU 213-1. Description will be given with reference to FIG. 18.

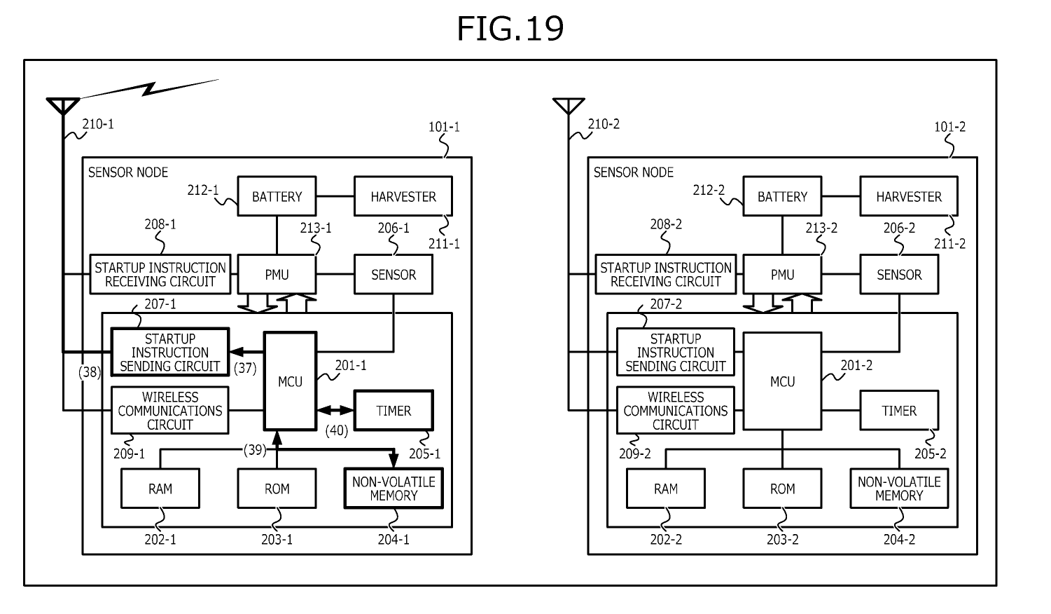

In FIG. 18, (36) when receiving the request to start the power supply, the PMU 213-1 starts the power supply to the MCU 201, the ROM 203-1, etc. As a result, the MCU 201-1 starts activation. A timer 205-1 starts the measurement of the elapsed time. Description will be given with reference to FIG. 19.

In FIG. 19, when the MCU 201-1 becomes activated and ready for the reception of the data 300, the MCU 201-1 executes a process corresponding to the event that has occurred. In this case, the MCU 201-1 relays the process result to the parent node 102 via other sensor nodes 101 within the communication area.

(37) Thus, the MCU 201-1 sends to a startup instruction sending circuit 207-1, a request to send a startup instruction to start up the sensor nodes 101 within the communication area. (38) When receiving the send request, the startup instruction sending circuit 207-1 sends the startup instruction within the communication area via the antenna 210-1.

(39) When sending the send request, the MCU 201-1 reads from the non-volatile memory 204-1, the startup period of the MCU 201-2 stored at (33). Subsequently, the MCU 201-1 sets the read startup time as the standby period. (40) The MCU 201-1 acquires the elapsed time at the point of sending of the send request from the timer 205-1.

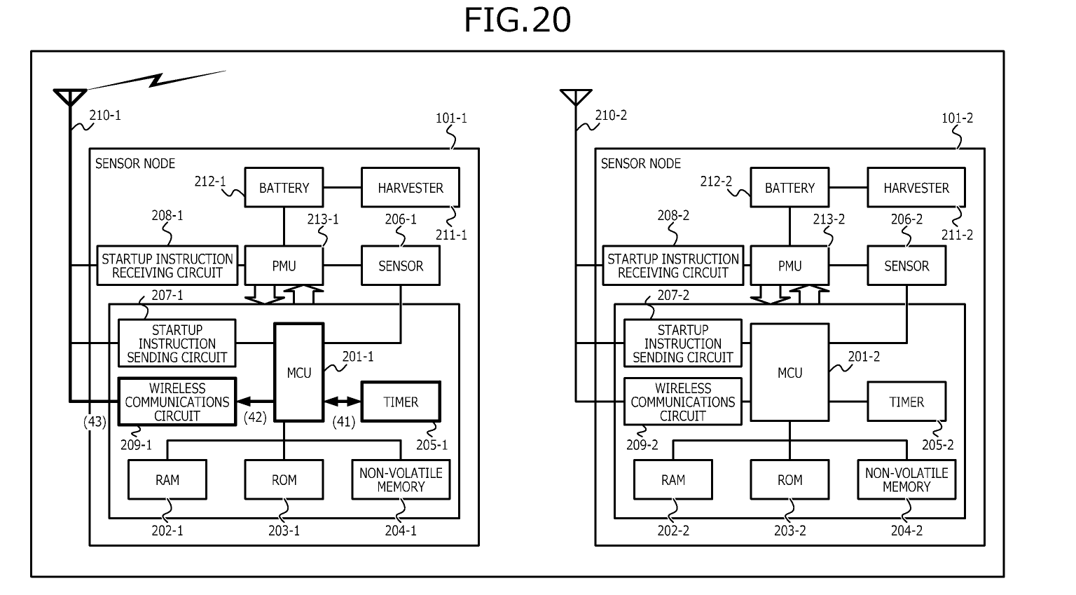

Here, the sensor node 101-2, similar to FIGS. 10 to 12, is assumed to receive the startup instruction sent at (38) and to activate the MCU 201-2. Description will be given with reference to FIG. 20.

In FIG. 20, (41) the MCU 201-2 acquires the elapsed time measured by the timer 205-1. Using the acquired elapsed time and the elapsed time at the point of time of sending of the send request acquired at (40), the MCU 201-1 then determines whether the standby period set at (39) has elapsed. In this example, it is assumed that the standby period has elapsed.

(42) Upon determining that the standby period has elapsed, the MCU 201-1 sends a request to send a process result to a wireless communications circuit 209-1. (43) When receiving the send request, the wireless communications circuit 209-1 sends the process result within the communication area via the antenna 210-1.

Subsequently, similar to FIGS. 14 and 15, the sensor node 101-2 sends the response 400. Similar to FIG. 16, the sensor node 101-1 receives the response 400. In this manner, the sensor node 101 allows another sensor node 101 within the communication area to receive the data 300, to perform communication of the data 300. Thereafter, when the communication of the data 300 ends, the sensor node 101-1 suspends the power supply to the MCU 201-1, the ROM 203-1, etc. Similarly, when the communication of the data 300 ends, the sensor node 101-2 suspends the power supply to the MCU 201-2, the ROM 203-2, etc.

This enables the sensor node 101-1 to send the data 300 immediately after the sensor node 101-2 is ready for the reception, so that the standby period can be curtailed. Curtailment of the standby period enables the sensor node 101-2 to shorten the time of the power supply to the MCU 201-1, the ROM 203-1, etc., resulting in reduced power consumption.

Due to no need to send a response to the startup instruction, the sensor node 101-2 can save the power consumed for the sending of the response. Curtailing the standby period further enables the sensor node 101-1 to shorten the processing time for an event that has occurred.

In the case of receiving a startup instruction when the MCU 201 has already been activated, the sensor node 101 need not measure the elapsed time by the timer 205 but merely has to send the startup period stored in the non-volatile memory 204.

With reference to FIGS. 21 and 22, a setting example 1 of the standby period will be described in a case where the sensor node 101 receives the response 400 from plural sensor nodes.

FIGS. 21 and 22 are explanatory views of the setting example 1 of the standby period in a case of receiving the response 400 from the plural sensor nodes 101. In FIG. 21, (51) the sensor node 101-1 sends a startup instruction in the communication area. As a result, sensor nodes 101-2 to 101-6 receive a startup instruction. (52) The sensor node 101-1 then sends the data 300 within the communication area. As a result, the sensor nodes 101-2 to 101-6 receive the data 300. Description will be given with reference to FIG. 22.

In FIG. 22, (53) the sensor node 101-2 sends the response 400 including a startup period “30 milliseconds (ms)” to the sensor node 101-1. (54) The sensor node 101-1 receives the response 400 sent from the sensor node 101-2 and extracts the startup period “30 ms” from the received response 400. The sensor node 101-1 then employs the extracted startup period “30 ms” as the standby period and stores the startup period to the non-volatile memory 204.

(55) A sensor node 101-3 sends the response 400 including the startup period “32 ms” to the sensor node 101-1. (56) The sensor node 101-1 receives the response 400 sent from the sensor node 101-3 and extracts the startup period “32 ms” from the received response 400.

The sensor node 101-1 then compares the standby period “30 ms” stored in the non-volatile memory 204 and the extracted startup period “32 ms”. Since as a result of the comparison, the startup period is longer than the current standby period, the sensor node 101-1 updates the standby period “30 ms” to “32 ms”, which in turn is stored to the non-volatile memory 204.

(57) The sensor node 101-4 sends a response 400 including a startup period “35 ms” to the sensor node 101-1. (58) The sensor node 101-1 extracts the startup period “35 ms” similarly to (55) and, since the startup period is longer than the current standby period, updates the standby period “32 ms” to “35 ms”, which in turn is stored to the non-volatile memory 204.

(59) The sensor node 101-5 sends a response 400 including a startup period “39 ms” to the sensor node 101-1. (60) The sensor node 101-1 extracts the startup period “39 ms” similarly to (55) and, since the startup period is longer than the current standby period, updates the standby period “35 ms” to “39 ms”, which in turn is stored to the non-volatile memory 204.

(61) A sensor node 101-6 sends a response 400 including the startup period “38 ms” to the sensor node 101-1. (62) The sensor node 101-1 receives the response 400 sent from the sensor node 101-6 and extracts the startup period “38 ms” from the received response 400. The sensor node 101-1 then compares the standby period “39 ms” stored in the non-volatile memory 204 and the extracted startup period “38 ms”. Since as a result of the comparison, the startup period is shorter than the current standby period, the sensor node 101-1 does not update the standby period “39 ms”.

This enables the sensor node 101-1 to determine a standby period before the sensor nodes 101-2 to 101-6 in the communication area become activated and ready for the reception, and store the standby period to the non-volatile memory 204. As a result, the sensor node 101-1 sends the data 300 using the determined standby period so that the sensor nodes 101-2 to 101-6 can receive the data 300.

With reference to FIG. 23, description will be given of a data sending process performed by the sensor node 101 in a case of employing the setting example 1. The data sending process is a process executed by the sensor node 101 having the sending-side function depicted in FIG. 5 and is executed, for example, by the sensor node 101-1 depicted in FIGS. 7 to 20.

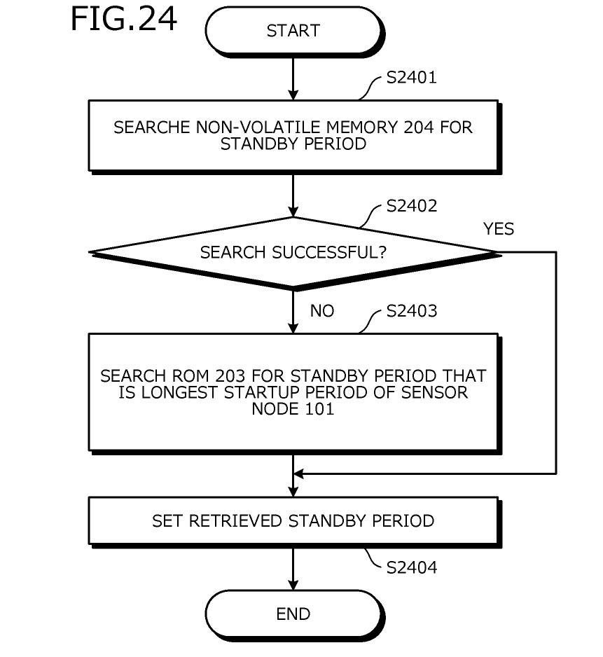

FIG. 23 is a flowchart of an example of the data sending process performed by the sensor node 101 in a case of employing the setting example 1. In FIG. 23, the sensor node 101 first sends a startup instruction (step S2301). The sensor node 101 sets a standby period by the process depicted in FIG. 24 (step S2302).

The sensor node 101 determines whether the standby period has elapsed (step S2303). If the standby period has not elapsed (step S2303: NO), the sensor node 101 returns to the operation at step S2303 to wait the elapse of the standby period.

On the other hand, if the standby period has elapsed (step S2303: YES), the sensor node 101 sends the data 300 (step S2304), and ends the data sending process. This enables the sensor node 101 to start up another sensor node 101 in the communication area to send the data 300 after the other sensor node 101 is ready for the reception. As a result, the sensor node 101 enables the other sensor node 101 in the communication area to receive the data 300.

With reference to FIG. 24, description will be given of a standby period setting process performed by the sensor node 101 in the case of employing the setting example 1. The standby period setting process is a process executed at step S2302.

FIG. 24 is a flowchart of an example of the standby period setting process performed by the sensor node 101 in the case of employing the setting example 1. In FIG. 24, the sensor node 101 first searches the non-volatile memory for a standby period (step S2401). The sensor node 101 then determines whether a standby period has been retrieved (step S2402).

If no standby period has been retrieved (step S2402: NO), the sensor node 101 searches the ROM 203 for the standby period that is the longest startup period of the sensor node 101 (step S2403), and transitions to the operation at step S2404.

On the other hand, if a standby period has been retrieved (step S2402: YES), the sensor node 101 sets the retrieved standby period (step S2404), and end the standby period setting process. This enables the sensor node 101 to set the standby period at the time of the first communication and at the time of the second and subsequent communications.

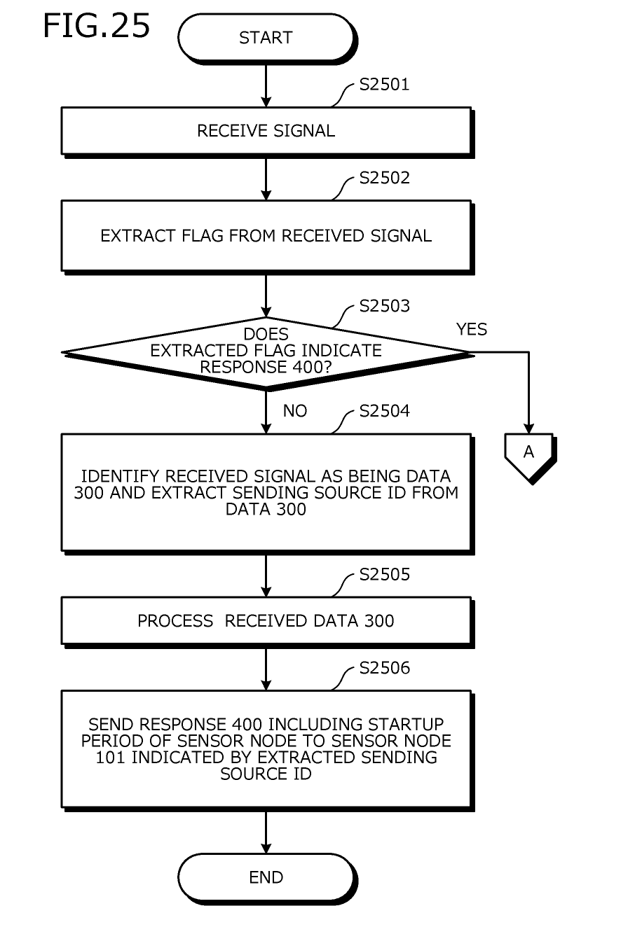

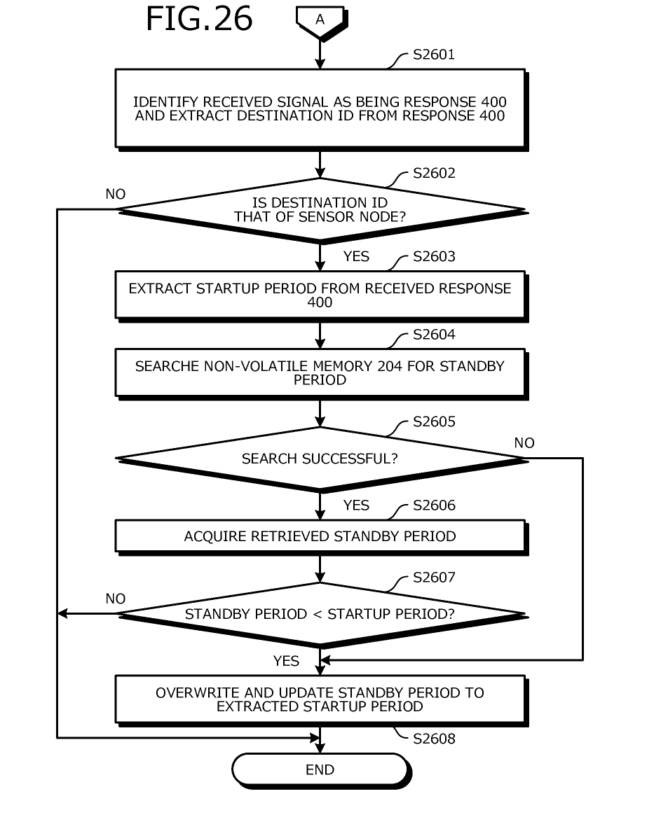

With reference to FIGS. 25 and 26, description will be given of a data receiving process performed by the sensor node 101 in the case of employing the setting example 1. The data receiving process is a process executed by the sensor node 101 having the sending-side function depicted in FIG. 5 and by the sensor node 101 having the receiving-side function depicted in FIG. 6. The data receiving process is executed by the sensor nodes 101-1 and 101-2 depicted in FIGS. 7 to 20.

FIGS. 25 and 26 are flowcharts of an example of the data receiving process performed by the sensor node 101 in the case of employing the setting example 1. In FIG. 25, the sensor node 101 receives a signal (step S2501). The sensor node 101 then extracts a flag from the received signal (step S2502).

The sensor node 101 determines whether the extracted flag indicates a response 400 (step S2503). If the flag indicates the response 400 (step S2503: YES), the sensor node 101 shifts to the operation at step S2601 of FIG. 26.

On the other hand, if the flag does not indicate the response 400 (step S2503: NO), the sensor node 101 identifies the received signal as being the data 300 and extracts a sending source ID from the data 300 (step S2504).

The sensor node 101 processes the received data 300 (step S2505). For example, processing of the data 300 may be a relay process of the data 300 or may be an analysis process of the data contents of the data 300. For example, processing of the data 300 may be an upload process of the data 300 to a server that is an external device or may be a notification process of the data 300 to a user terminal that is an external device.

The sensor node 101 sends the response 400 including the startup period of the sensor node to another sensor node 101 indicated by the extracted sending source ID (step S2506, and ends the data receiving process. The operations at steps S2501 to 2506 enable the sensor node 101 to process the data 300 sent from another sensor node 101, and to send a response 400 to the data 300.

Description will be given with reference to FIG. 26. In FIG. 26, the sensor node 101 identifies the received signal as being the response 400 and extracts a destination ID from the response 400 (step S2601). The sensor node 101 determines whether the destination ID is the ID of that sensor node 101 (step S2602). If the destination ID is not the ID of that sensor node (step S2602: NO), the sensor node 101 terminates the data receiving process.

On the other hand, if the destination ID is the ID of that sensor node 101 (step S2602: YES), the sensor node 101 extracts a startup period from the received response 400 (step S2603). The sensor node 101 searches the non-volatile memory 204 for a standby period (step S2604).

The sensor node 101 determines whether the search is successful (step S2605). If not (step S2605: NO), the sensor node 101 transitions to the process at step S2608.

If successful (step S2605: YES), the sensor node 101 acquires the retrieved standby period (step S2606), and determines whether the acquired standby period is shorter than the extracted startup period (step S2607). If not (step S2607: NO), the sensor node 101 ends the data receiving process.

On the other hand, if the acquired standby period is shorter than the extracted startup period (step S2607: YES), the sensor node 101 overwrites the standby period to the extracted startup period, as updating (step S2608), and ends the data receiving process. The operations from steps S2601 to 2608 enable the sensor node 101 to process the response 400 to the data 300 sent from that sensor node, to update the standby period.

With reference to FIGS. 27 to 29, description will be given of a setting example 2 of the standby period in a case of receiving responses 400 from plural sensor nodes 101.

FIG. 27 is an explanatory view of the density of sensor nodes 101. As depicted in FIG. 27, the sensor nodes 101 are arranged at random in the sensor network 100. Accordingly, deviation in the density of the sensor nodes 101 may occur according to the installation site.

For example, five sensor nodes 101 (sensor nodes 101-2 to 101-6) are in a communication area 2701 of the sensor node 101-1. Three sensor nodes 101 (sensor nodes 101-8 to 101-1-) are in a communication area 2702 of a sensor node 101-7.

In this case, the sensor node 101 need not necessarily cause all of the sensor nodes 101 within the communication area 2701 to receive the data 300. For example, the sensor node 101-1 may cause three sensor nodes 101 among the five sensor nodes 101 within the communication 2701 to receive the data 300. In this case, the sensor node 101-1 is allowed to send data 300 instantly when the three sensor nodes 101 become ready for the reception, without standing by until the five sensor nodes 101 within the communication area 2701 to become ready for the reception.

Thus, by employing as the standby period, the third shortest startup period among the startup periods of the sensor nodes 101 within the communication area 2701, the sensor node 101-1 may stand by until the three sensor nodes 101 become ready for the reception. This enables the sensor node 101-1 to shorten the standby period as compared with the case of employing as the standby period, the longest startup period among the startup periods of the sensor nodes within the communication area 2701.

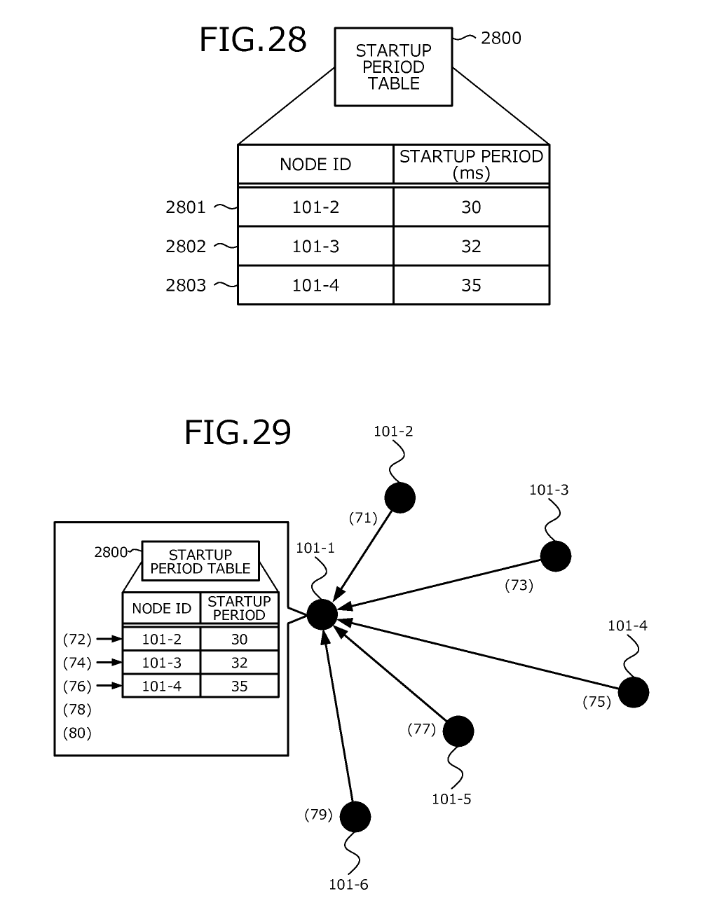

For example, to employ as the standby period, the third shortest startup period among the startup periods of the sensor nodes 101 within the communication area 2701, the sensor node 101 uses a startup period table depicted in FIG. 28.

FIG. 28 is an explanatory view of an example of the storage contents of the startup period table. To employ the standby period for a predetermined number of sensor nodes 101 to become ready for the reception, the startup period table stores startup periods of the predetermined number of sensor nodes 101. The startup period table is realized, for example, by a storage device such as the ROM 203, the RAM 202, and the non-volatile memory 204.

As depicted in FIG. 28, a startup period table 2800 has a startup period field correlated with a node ID field, with information being set in each field for each sensor node 101 to form a predetermined number of records or less (three records 2801 to 2803 in the example of FIG. 28).

An identifier of the sensor node 101 is stored in the node ID field. A startup period of the sensor node 101 indicated by the identifier in the node ID field is stored in the startup period field. For example, a record 2801 is information indicating that the startup period of the sensor node 101-2 is “30 ms”.

FIG. 29 is an explanatory view of the setting example 2 of the standby period using the startup period table 2800. Similar to FIG. 21, in FIG. 29 that the sensor node 101-1 is assumed to send the data 300 after sending startup instructions within the communication area.

(71) The sensor node 101-2 sends a response 400 including a startup period “30 ms” to the sensor node 101-1. (72) The sensor node 101-1 receives the response 400 sent from the sensor node 101-2 and extracts the startup period “30 ms” from the received response 400. The sensor node 101-1 then stores into the startup period table 2800, a record in which an ID “101-2” of the sensor node 101-2 as the sending source of the response 400 is correlated with the extracted startup period “30 ms”.

(73) The sensor node 101-3 sends a response 400 including a startup period “32 ms” to the sensor node 101-1. (74) Similar to (72), the sensor node 101-1 stores into the startup period table 2800, a record in which an ID “101-3” of the sensor node 101-3 as the sending source of the response 400 is correlated with the extracted startup period “32 ms”.

(75) The sensor node 101-4 sends a response 400 including a startup period “35 ms” to the sensor node 101-1. (76) Similar to (72), the sensor node 101-1 stores into the startup period table 2800, a record in which an ID “101-4” of the sensor node 101-4 as the sending source of the response 400 is correlated with the extracted startup period “35 ms”.

(77) The sensor node 101-5 sends a response 400 including a startup period “39 ms” to the sensor node 101-1. (78) The sensor node 101-1 receives the response 400 sent from the sensor node 101-5 and extracts the startup period “39 ms” from the received response 400. Here, the startup period table 2800 has three records and therefore, the sensor node 101-1 compares the startup period of each of the records with the extracted startup period “39 ms”. Subsequently, from the result of comparison, since the extracted startup period is longer than that of each of the records, the sensor node 101-1 does not create a record related to the startup period “39 ms”.

(79) The sensor node 101-6 sends a response 400 including a startup period “38 ms” to the sensor node 101-1. (80) Similar to (78), the sensor node 101-1 compares the startup period of each of the records in the startup period table 2800 with the extracted startup period “38 ms”. Subsequently, from the result of comparison, since the extracted startup period is longer than that of each of the records, the sensor node 101-1 does not create a record related to the startup period “38 ms”.

Thereby, the sensor node 101-1 stores in the startup period table 2800, the first to third shortest startup periods among startup periods of the sensor nodes 101-2 to 101-6 in the communication area. The sensor node 101-1 then employs as the standby period, the third shortest startup period stored in the startup period table 2800.

This enables the sensor node 101-1 to determine a standby period before the three sensor nodes in the communication area become ready for the reception, and to store the standby period to the non-volatile memory 204. As a result, the sensor node 101-1 sends the data 300 using the determined standby period so that the three sensor nodes 101 can receive the data 300.

In the case of receiving a response 400 from another sensor node 101 whose startup period is stored in the startup period table 2800, the sensor node 101 may update the startup period stored in the startup period table 2800 to the startup period included in the received response. This enables the sensor node 101 to update the startup period of the startup period table 2800 to the most current status.

Description will be given of a data sending process performed by the sensor node 101 in the case of employing the setting example 2. The data sending process employing the setting example 2 is similar to the data sending process employing the setting example 1 depicted in FIG. 23, and therefore will not again be described.

A standby period setting process will be described that is performed by the sensor node 101 in the case of employing the setting example 2. The standby period setting process employing the setting example 2 is similar to the standby period setting process employing the setting example 1 depicted in FIG. 24, and therefore will not again be described.

In the setting example 2, at step S2401 the sensor node 101 searches for the longest startup period in the startup period table 2800. This enables the sensor node 101 to set the standby period before a predetermined number of sensor nodes 101 become ready for the reception among sensor nodes 101 in the communication area.

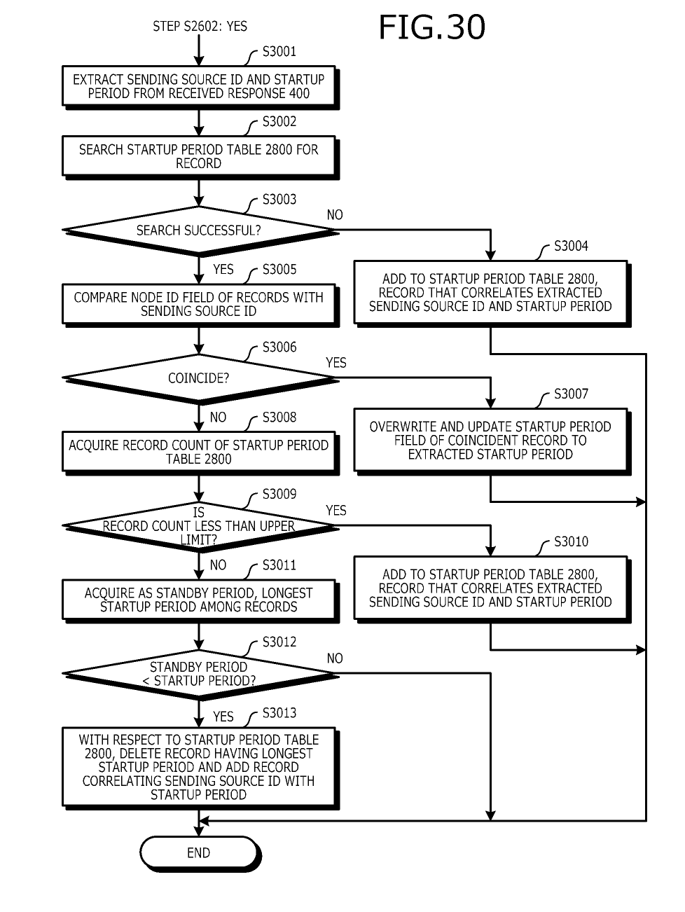

With reference to FIG. 30, a data receiving process will be described that is performed by the sensor node 101 in the case of employing the setting example 2. The data receiving process employing the setting example 2 is similar to the data receiving process employing the setting example 1 depicted in FIGS. 25 and 26 in steps S2501 to S2506 and S2601 to S2602 and a branch from S2602: NO. Therefore, a branch from step S2602: YES depicted in FIG. 26 will be described herein in the case of employing the setting example 2.

FIG. 30 is a flowchart of an example of the data receiving process performed by the sensor node 101 in the case of employing the setting example 2. In FIG. 30, the sensor node 101 extracts a sending source ID and a startup period from the received response 400 (step S3001).

The sensor node 101 searches the startup period table 2800 for a record (step S3002). The sensor node 101 determines whether the search is successful (step S3003). If not (step S3003: NO), the sensor node 101 adds to the startup period table 2800, a record that correlates the extracted sending source ID and the startup period (step S3004), and ends the data receiving process.

On the other hand, if the search is successful (step S3003: YES), the sensor node 101 compares the node ID field of the records in the startup period table 2800 with the sending source ID (step S3005). The sensor node 101, from the comparison, determines whether the node IDs coincide (step S3006). If coincident (step S3006: YES), the sensor node 101 overwrites and updates the startup period field of the coincident record to the extracted startup period (step S3007), and ends the data receiving process.

On the other hand, if not coincident (step S3006: NO), the sensor node 101 acquires a record count of the startup period table 2800 (step S3008). The sensor node 101 then determines whether the record count is less than an upper limit (step S3009). If the record count is less than the upper limit (step S3009: YES), the sensor node 101 adds to the startup period table 2800, a record that correlates the extracted sending source ID and startup period (step S3010), and ends the data receiving process.

On the other hand, if the record count is not less than the upper limit (step S3009: NO), the sensor node 101 acquires as the standby period, the longest startup period in the records of the startup period table 2800 (step S3011). The sensor node 101 then determines whether the acquired standby period is shorter than the extracted startup period (step S3012). If not (step S3012: NO), the sensor node 101 terminates the data receiving process.

On the other hand, if the acquired standby period is shorter (step S3012: YES), the sensor node 101 deletes the record that includes the longest startup period among the records in the startup period table 2800 and adds a record correlating the sending source ID with the startup period to the startup period table 2800 (step S3013), and ends the data receiving process. This enables the sensor node 101 to store a predetermined number of startup periods of the sensor nodes in the communication area, in ascending order from the shortest one.

As described above, the disclosed communications apparatus (e.g., the sensor node 101) sets, in advance, a standby period based on a startup period of another communications apparatus sent from the other communications apparatus in the communication area and, after sending startup instructions in the communication area, sends the data 300 within the communication area when the set standby period has elapsed. Thereby, the disclosed communications apparatus can allow the other communications apparatus to receive the data 300 after the other communications apparatus 300 has become ready for the reception.

Accordingly, the communications apparatus can shorten the standby period to reduce power consumption, as compared with a case of a fixed standby period. The disclosed communications apparatus can send the data 300 without receiving a response to the startup instruction, so that the communications apparatus need not specify the number of the other communications apparatuses lying within the communication area.

The other communications apparatuses need not send a response to the startup instruction. This enables the other communications apparatuses to curtail the sending process of the response 400, to reduce the process amount and reduce power consumption. As compared with the case of sending data 300 upon reception of a response to the startup instruction, the disclosed communications apparatus can curtail the time taken for the reception of a response to the startup instruction so that the standby period can be reduced and so that the power consumption can be reduced.

At the time of the first communication, the disclosed communications apparatus sets, in advance, a standby period based on the longest startup period consequent to manufacturing deviations of the communications apparatus and, after sending startup instructions within the communication area, sends the data 300 within the communication area when the set standby period has elapsed. Thereby, also at the first communication, the disclosed communications apparatus can allow the other communications apparatuses within the communication area to receive data 300 after the other communications apparatuses have become ready for the reception of the data 300. The disclosed communications apparatus can send the data 300 without receiving a response to the startup instruction, so that the communications apparatus need not specify the number of the other communications apparatuses lying within the communication area.

In a case where plural other communications apparatuses lie within the communication area, the disclosed communications apparatus sets a standby period based on the longest startup period among startup periods of the other communications apparatuses. Thereby, the disclosed communications apparatus can allow each of the other communications apparatuses to receive the data 300.

In a case where plural other communications apparatuses lie within the communication area, the disclosed communications apparatus sets a standby period based on a x-th shortest startup period among startup periods of the other communications apparatuses. Thereby, the disclosed communications apparatus can allow other communications apparatuses having the shortest to the x-th shortest standby periods in ascending order to receive the data 300.

In a case where the number of the responses 400 to the sent data 300 is less than or equal to a predetermined value, the disclosed communications apparatus extends the set standby period. This enables the disclosed communications apparatus to extend the standby period to standby until the other communications apparatuses complete respective startups, if the other communications apparatuses have come to have extended startup periods due to deterioration with age, etc.

In a case where the communications apparatus does not know the number of other communications apparatuses lying within the communication area to which the apparatus belongs, the communications apparatus may be configured to receive responses from other communications apparatuses within the communication area to send data to only thereto. In this configuration, however, the communications apparatus has an increased processing time due to the reception of the responses and therefore, has a longer standby period before the sending of the data. Furthermore, if the communications apparatus sends data each time the communications apparatus receives a response, the network traffic increases and may result in congestion.

On the other hand, since the disclosed communications apparatus sends data 300 upon the elapse of the standby period, the disclosed communications apparatus can send the data 300 without specifying the number of other communications apparatuses lying within the communication area of the apparatus. The disclosed communications apparatus can send data 300 immediately after another communications apparatus has become active, irrespective of the presence or absence of a response 400 from the other communications apparatus, so that the standby period can be curtailed. Since the disclosed communications apparatus allows another communications apparatus not to have to send a response 400, network congestion can be suppressed.

In a case where the communications apparatus does not know the number of other communications apparatuses lying within the communication area to which the apparatus belongs, the communications apparatus may be configured to receive responses from other communications apparatus within the communication area in a standby period previously decided by the developer, etc., of the communications apparatus, and to send data to only the other communications apparatuses from which a response have been received. In this configuration, however, the communications apparatus has to stand by until the elapse of the standby period even though the communications apparatus has received responses from the other communications apparatuses within the communication area in the standby period, resulting in a longer standby period. In this configuration, the communications apparatus may not receive responses from all of communications apparatuses used for the configuration of the network in the standby period and in consequence, the network cannot be configured.

On the other hand, since the disclosed communications apparatus sends the data 300 upon the elapse of the standby period, the disclosed communications apparatus can send the data 300 without specifying the number of the other communications apparatuses lying within the communication area of the apparatus. The disclosed communications apparatus can send data 300 immediately after another communications apparatus has become active, irrespective of the presence or absence of a response 400 from the other communications apparatus, so that the standby period can be curtailed. The disclosed apparatuses can send the data 300 after all of communications apparatuses for use in the configuration of the network have become ready for reception of the data 300.

The communications method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

The communications apparatus described in the present embodiment can be realized by an application specific integrated circuit (ASIC) such as a standard cell or a structured ASIC, or a programmable logic device (PLD) such as a field-programmable gate array (FPGA). Specifically, for example, functional units (receiving unit 601 to transmitting unit 604 of the communications apparatus are defined in hardware description language (HDL), which is logically synthesized and applied to the ASIC, the PLD, etc., thereby enabling manufacture of the communications apparatus.

According to one aspect, an effect is achieved in that the wait time until data is sent can be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communications apparatus comprising:
a receiving circuit that, when sending a startup instruction to start up another communications apparatus within a communication area, receives from the other communications apparatus, information indicating a period required for startup of the other communications apparatus;
a processor that stores to a storage device, a standby period based on the period indicated by the information received by the receiving circuit;
a communications circuit that sends the startup instruction within the communication area; and
a timer that detects that the standby period stored in the storage device by the processor has elapsed after sending of the startup instruction from the communications circuit, wherein
the communications circuit sends data within the communication area when the timer detects that the standby period has elapsed.

2. The communications apparatus according to claim 1, wherein
the processor stores to the storage device, the standby period based on a longest period among periods indicated by the information, when the receiving circuit receives the information from a plurality of the other communications apparatuses.

3. The communications apparatus according to claim 1, wherein
the processor stores to the storage device, the standby period based on an x-th shortest period among periods indicated by the information, when the receiving circuit receives the information from a plurality of the other communications apparatuses.

4. The communications apparatus according to claim 1, wherein
the processor extends the standby period stored to the storage device when from a plurality of the other communications apparatuses, a count of responses to the data sent from the communications circuit is less than or equal to a predetermined value.

5. The communications apparatus according to claim 1, wherein
the storage device retains therein a standby period greater than or equal to a longest startup period of a plurality of the other communications apparatuses before the receiving circuit receives the information.

6. A communications apparatus comprising:
a receiving circuit that receives a startup instruction from a sending source that sends data after a predetermined standby period elapses since a sending of the startup instruction;
a power management unit that activates a processor in the communications apparatus when the receiving circuit receives the startup instruction;
a timer that measures a period that elapses until a reception process for the data by the processor activated by the power management unit becomes possible after the receiving circuit receives the startup instruction; and
a communications circuit that sends to the sending source, information indicating the period measured by the timer.

7. A communications method executed by a computer, the communications method comprising:
receiving from another communications apparatus,
information indicating a period required for startup of the other communications apparatus, when sending a startup instruction to start up the other communications apparatus within a communication area;
storing to a storage device, a standby period based on the period indicated by the received information;
sending the startup instruction within the communication area; and
detecting that the standby period stored to the storage device has elapsed after sending of the startup instruction; and
sending data within the communication area when detecting that the standby period has elapsed.

8. A communications method executed by a computer, the communications method comprising:
receiving a startup instruction from a sending source that sends data after a predetermined standby period elapses since a sending of the startup instruction;
activating an internal processor when receiving the startup instruction;
measuring a period that elapses until a reception process for the data by the activated processor becomes possible after receiving the startup instruction; and
sending to the sending source, information indicating the measured period.

9. A non-transitory, computer-readable recording medium storing therein a communications program causing a computer to execute a process comprising:
receiving from another communications apparatus,
information indicating a period required for startup of the other communications apparatus, when sending a startup instruction to start up the other communications apparatus within a communication area;
storing to a storage device, a standby period based on the period indicated by the received information;
sending the startup instruction within the communication area; and
detecting that the standby period stored to the storage device has elapsed after sending of the startup instruction; and
sending data within the communication area when detecting that the standby period has elapsed.

10. A non-transitory, computer-readable recording medium storing therein a communications program causing a computer to execute a process comprising:
receiving a startup instruction from a sending source that sends data after a predetermined standby period elapses since a sending of the startup instruction;
activating an internal processor when receiving the startup instruction;
measuring a period that elapses until a reception process for the data by the activated processor becomes possible after receiving the startup instruction; and
sending to the sending source, information indicating the measured period.

11. A communications system comprising:
a first communications apparatus; and
a second communications apparatus, wherein
the first and the second communications apparatuses are disposed in a mutually communicable area,
the first communications apparatus, when receiving a startup instruction, activates a processor in the first communications apparatus and sends to the second communications apparatus, a measurement result of a period elapsing until a reception process for data by the activated processor becomes possible after reception of the startup instruction, and
the second communications apparatus receives the measurement result sent from the first communications apparatus, stores a standby period based on the received measurement result into a storage device, sends the startup instruction within an area communicable from the second communications apparatus, and upon detecting that the standby period stored to the storage device has elapsed after sending the startup instruction, sends the data within the area communicable from the second communications apparatus.
